(19) United States
(12) Patent Application Publication
(10) Pub. No.: US 2019/0347733 A1
(43) Pub. Date: Nov. 14, 2019

(54) INFORMATION PROCESSING APPARATUS, INFORMATION PROCESSING METHOD, AND PROGRAM

(71) Applicant: SONY CORPORATION, TOKYO (JP)

(72) Inventors: TAKAHIRO SASAKI, KANAGAWA (JP); TAKAO TAJIRI, TOKYO (JP)

(21) Appl. No.: 16/307,279

(22) PCT Filed: Jan. 24, 2017
(86) PCT No.: PCT/JP2017/002320

§ 371 Date: Dec. 5, 2018

Related U.S. Application Data
(60) Provisional application No. 62/352,805, filed on Jun. 21, 2016.

(51) Int. Cl. G06Q 40/06; G06F 3/14

(52) U.S. Cl. CPC G06Q 40/06; G06F 3/14

(57) ABSTRACT

[Object] To plan asset management with an awareness of the occurrence of each event.

[Solution] An information processing apparatus includes a control unit that creates an asset management plan for each event on the basis of event information including a goal sum and an achievement time for every event.

### TECHNICAL FIELD

The present disclosure relates to an information processing apparatus, an information processing method, and a program.

### BACKGROUND ART

Recently, robo-advisors are being provided widely as a service related to asset management. A robo-advisor is a service that asks a client several questions, evaluates risk preferences from the responses to the questions, and provides advice regarding a portfolio (a combination of financial products) that matches the client's risk preferences. In addition, a system for optimizing a portfolio is also described in Patent Literature 1, for example.

### CITATION LIST

### Patent Literature

Patent Literature 1: JP 2014-63297A

### DISCLOSURE OF INVENTION

### Technical Problem

People experience a variety of life events that are associated with expenditures, such the purchase of a home, the education of one's children, and the replacement purchase of a car. However, in the above robo-advisors, asset management tailored to each event is not proposed.

Accordingly, the present disclosure proposes a novel and improved information processing apparatus, information processing method, and program capable of planning asset management with an awareness of the occurrence of each event.

### Solution to Problem

According to the present disclosure, there is provided an information processing apparatus including: a control unit that creates an asset management plan for each event on the basis of event information including a goal sum and an achievement time for every event.

In addition, according to the present disclosure, there is provided an information processing method including: acquiring a setting of a goal sum and an achievement time for every event; and creating, by a processor, an asset management plan for each event on the basis of the setting for every event.

In addition, according to the present disclosure, there is provided a program causing a computer to function as: a control unit that creates an asset management plan for each event on the basis of a setting of a goal sum and an achievement time for every event.

### Advantageous Effects of Invention

According to the present disclosure as described above, it is possible to plan asset management with an awareness of the occurrence of each event.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is an explanatory diagram illustrating a configuration of an asset administration system according to an embodiment of the present disclosure.

FIG. 2 is an explanatory diagram illustrating an example portfolio.

FIG. 3 is an explanatory diagram illustrating specific examples of life events.

FIG. 4 is an explanatory diagram illustrating a specific example of portfolios created by the system according to the present disclosure.

FIG. 5 is an explanatory diagram illustrating a configuration of an administration server according to an embodiment of the present disclosure.

FIG. 6 is an explanatory diagram illustrating a specific example of an event selection screen.

FIG. 7 is an explanatory diagram illustrating a specific example of event selection buttons.

FIG. 8 is an explanatory diagram illustrating a specific example of event selection buttons.

FIG. 9 is an explanatory diagram illustrating a specific example of a goal setting screen.

FIG. 10 is an explanatory diagram illustrating a specific example of a plan display screen.

FIG. 11 is an explanatory diagram illustrating a specific example of a plan display screen that displays a combined result of the asset management plans for all events.

FIG. 12 is an explanatory diagram illustrating a specific example of a purchase request screen.

FIG. 13 is an explanatory diagram illustrating a specific example of a management conditions display screen.

FIG. 14 is an explanatory diagram illustrating a specific example of a management conditions display screen.

FIG. 15 is an explanatory diagram illustrating a specific example of a rebalancing screen.

FIG. 16 is an explanatory diagram illustrating a specific example of an adjustment screen.

FIG. 17 is an explanatory diagram illustrating the basic concept of an asset management plan creation method.

FIG. 18 is an explanatory diagram illustrating the concept of contribution amounts every period for each event.

FIG. 19 is an explanatory diagram illustrating a process of creating a contribution plan according to Logic 1.

FIG. 20 is an explanatory diagram illustrating a process of creating a contribution plan according to Logic 1.

FIG. 21 is an explanatory diagram illustrating a process of creating a contribution plan according to Logic 1.

FIG. 22 is an explanatory diagram illustrating a process of creating a contribution plan according to Logic 1.

FIG. 23 is an explanatory diagram illustrating a process of creating a contribution plan according to Logic 1.

FIG. 24 is a flowchart illustrating a method of creating a contribution plan according to an embodiment of the present disclosure.

FIG. 25 is a flowchart illustrating the flow of creating an asset management plan from a contribution plan.

FIG. 26 is an explanatory diagram illustrating a modification of a model for creating a contribution plan.

FIG. 27 is an explanatory diagram illustrating a modification of a model for creating a contribution plan.

FIG. 28 is an explanatory diagram illustrating a modification of a model for creating a contribution plan.

FIG. 29 is a block diagram illustrating a hardware configuration of an administration server.

FIG. 30 is an explanatory diagram illustrating an application of a risk-related setting.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that, in this description and the drawings, structural elements that have substantially the same function and structure are sometimes distinguished from each other using different alphabets after the same reference sign. However, when there is no need in particular to distinguish structural elements that have substantially the same function and structure, the same reference sign alone is attached.

In addition, the present disclosure will be described in the order indicated below.
1. Overview of asset administration system
2. Configuration of administration server
3. Details regarding display control
4. Creation of asset management plan
5. Rebalancing
6. Hardware configuration
7. Conclusion

### 1. OVERVIEW OF ASSET ADMINISTRATION SYSTEM

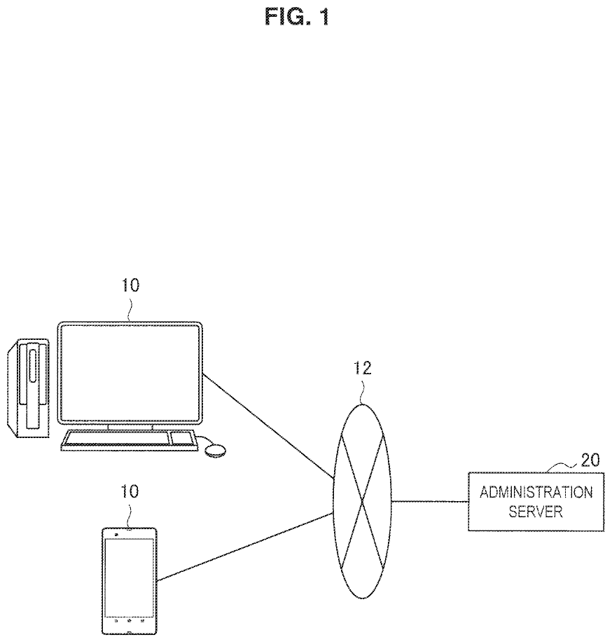

An embodiment of the present disclosure relates to an asset administration system that provides an asset management plan tailored to each client of a financial institution. First, FIG. 1 will be referenced to describe an overview of an asset administration system according to an embodiment of the present disclosure.

FIG. 1 is an explanatory diagram illustrating a configuration of the asset administration system according to an embodiment of the present disclosure. As illustrated in FIG. 1, the asset administration system according to an embodiment of the present disclosure includes a client terminal 10 and an administration server 20.

The client terminal 10 is an information processing apparatus used by a client, and includes a function of detecting operations by the client and a function of displaying a display screen. In the present embodiment, the client terminal 10 and the administration server 20 are connected via a communication network 12 as illustrated in FIG. 1, whereby the client terminal 10 displays a display screen received from the administration server 20 via the communication network 12, and detects operations performed by the client on the display screen. For example, the client terminal 10 displays a settings screen for information used to create an asset management plan, detects an operation of setting information on the settings screen, and transmits the set information to the administration server 20 via the communication network 12.

Note that the communication network 12 is a wired or wireless transmission path for information transmitted from an apparatus connected to the communication network 12. For example, the communication network 12 may include a public network such as the Internet, a telephone network, or a satellite communication network, various local area networks (LANs) including Ethernet (registered trademark), a wide area network (WAN), and the like. Additionally, the communication network 12 may also include a dedicated network such as an Internet Protocol virtual private network (IP-VPN).

The administration server 20 is an information processing apparatus that creates an asset management plan tailored to each client, and administers the client's assets according to the asset management plan. For example, the administration server 20 transmits a settings screen for information used to create an asset management plan to the client terminal 10, receives information set by the client on the settings screen from the client terminal 10, and creates an asset management plan tailored to the client of the client terminal 10 on the basis of the received information. Additionally, the administration server 20 administers the client's assets by buying and selling financial products according to the asset management plan on the basis of a request from the client. In addition, during the asset management period, the administration server 20 is also able to generate a display screen illustrating the management conditions of the client's assets, and transmit the generated display screen to the client terminal 10. Note that the administration server 20 may also be provided as one function of a financial institution such as a bank or a securities firm.

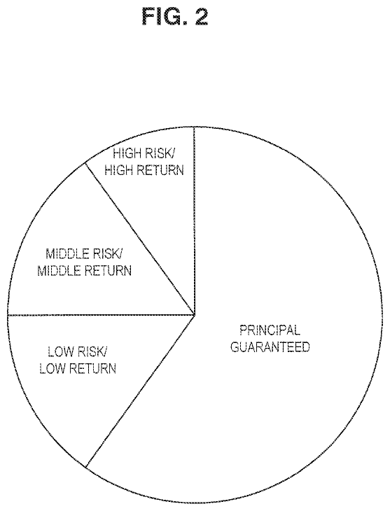

Incidentally, robo-advisors are known as a service related to asset management. A robo-advisor is a service that asks a client several questions, evaluates risk preferences from the responses to the questions, and provides advice regarding a portfolio that matches the client's risk preferences. According to the robo-advisor, as illustrated in FIG. 2, for example, a portfolio including a combination of multiple financial products having different risk/return characteristics may be formed easily.

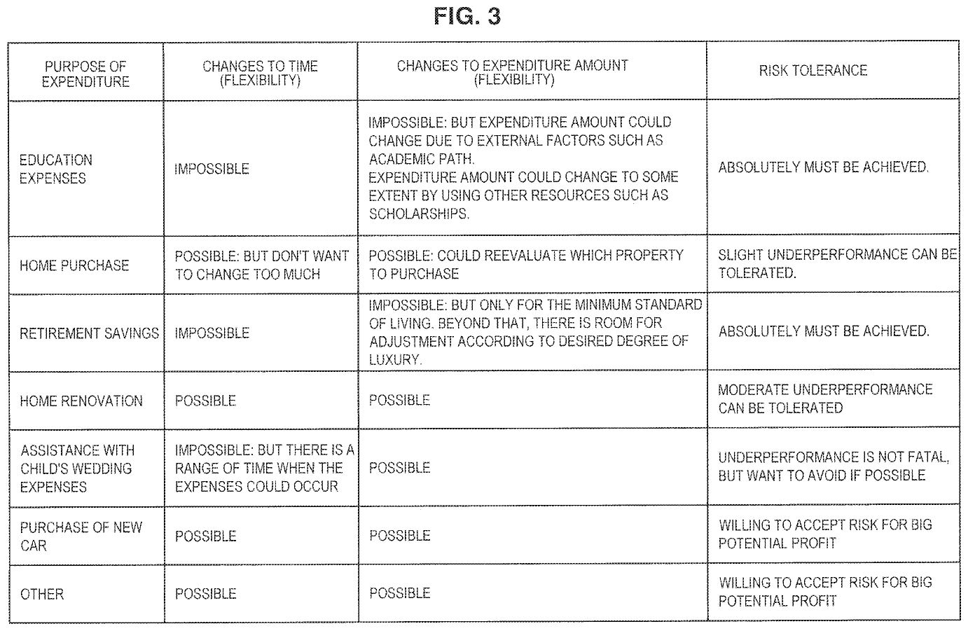

Meanwhile, people experience a variety of events (life events) that are associated with expenditures. FIG. 3 is an explanatory diagram illustrating specific examples of expenditures for events. As illustrated in FIG. 3, education expenses for one's child, expenses for a home purchase, retirement funds, home renovation expenses, assistance with wedding expenses for one's child, the replacement purchase of a car, and the like as given as examples of expenditures for events. Additionally, for every event, the expenditure amount, the ability to change the time, the ability to change the expenditure amount, and the risk tolerance (how much non-achievement is tolerated with respect to a goal sum) are different. For example, with regard to a home purchase, it is possible to change the purchase time and it is also possible to change the expenditure amount by reconsidering which property to purchase. For these reasons, slight underperformance of the management result with respect to the goal sum may be tolerated.

However, since the asset management by the robo-advisor described earlier does not take such events into consideration, the asset management is vague with no clearly defined purpose of the asset management, and there is a risk of being unprepared for the expenses of events that will occur in the future.

Accordingly, the present disclosure proposes a system that plans asset management with an awareness of the occurrence of events. In the system according to the present disclosure, since an asset management plan is created for every event and asset management is carried out according to the asset management plan, a portfolio is created for every event.

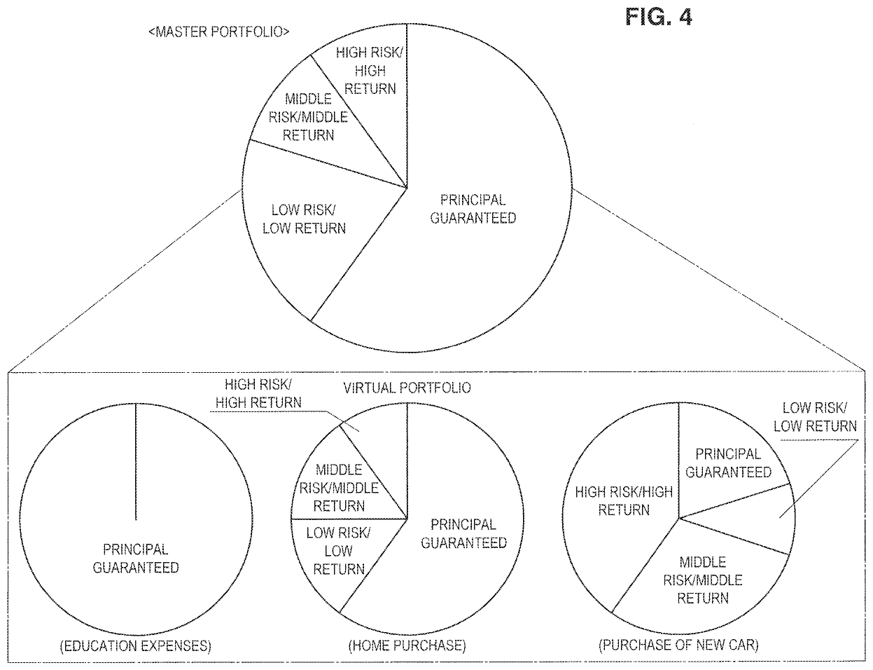

FIG. 4 is an explanatory diagram illustrating a specific example of portfolios created by the system according to the present disclosure. In the present disclosure, as illustrated in FIG. 4, a portfolio is administered for every event, such as education expenses, home purchase expenses, and car replacement expenses. However, these portfolios are virtual portfolios administered virtually inside a master portfolio created for the client's account. In other words, the result of combining each of the virtual portfolios is equivalent to the master portfolio. Note that since every event has a different risk tolerance, as illustrated in FIG. 4, the ratio of each financial product included in each virtual portfolio is also different.

In this way, according to the present disclosure, since an asset management plan is created for every event, and in addition, a virtual portfolio is administered for every event, it is possible to achieve asset management with an awareness of the occurrence of each event. Hereinafter, the configuration and the functions of the administration server 20 according to such an embodiment of the present disclosure will be successively described in detail.

### 2. CONFIGURATION OF ADMINISTRATION SERVER

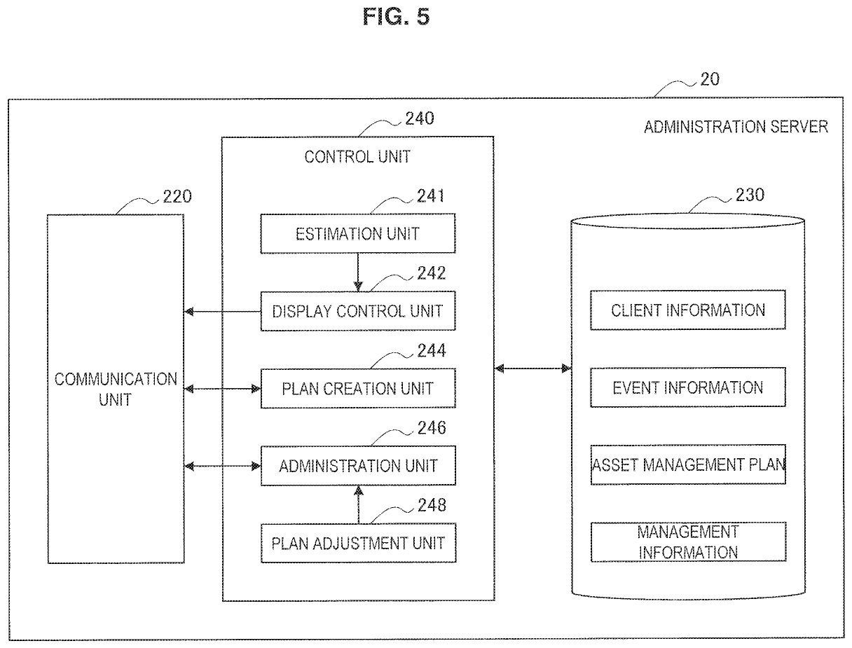

FIG. 5 is an explanatory diagram illustrating a configuration of the administration server 20 according to an embodiment of the present disclosure. As illustrated in FIG. 5, the administration server 20 according to an embodiment of the present disclosure is provided with a communication unit 220, a storage unit 230, and a control unit 240.

### (Communication Unit)

The communication unit 220 is an interface with external apparatus. For example, the communication unit 220 transmits an event settings screen, a display screen illustrating asset management conditions, and the like to the client terminal 10. Also, the communication unit 220 functions as an acquisition unit that acquires, from the client terminal 10, information about every event, such as a goal sum and an achievement time, set in the client terminal 10 on the event settings screen. Furthermore, the communication unit 220 also includes a function of transmitting buy orders and sell orders for financial products to an external transaction apparatus, under control by an administration unit 246 described later.

### (Storage Unit)

The storage unit 230 mainly stores client information, event information, an asset management plan, and management information.

The client information includes various information related to a client. For example, the client information may be a user profile (age, gender, occupation, family structure, residence, car ownership information, car purchase time), earnings information (salary, income, savings), expenditure information (living expenses, insurance, loans, term deposits, shopping), investment information (current invested amount, monthly contribution amount, amount available for investment), behavior information (movement information, SNS information), and the like.

The event information is information about each event set by the client. The event information may be event content (purpose of expenditure), a goal sum, an achievement time, and a risk tolerance (importance). In addition, the event information may also include information indicating the ability to vary the achievement time or the ability to vary the goal sum.

The asset management plan is information about every event indicating an initial investment amount and a monthly contribution amount to each financial product. Note that the asset management plan may also be information about every event indicating an initial investment amount and a monthly contribution amount to each financial product class rather than individual financial products. Financial product classes are classes into which financial products are classified according to the object of investment or the risk/return characteristics, such as emerging market bonds, Japanese stocks, and foreign bank debt. Additionally, the asset management plan may also include management prediction information (an expected management result). Such an asset management plan is created by a plan creation unit 244 described later.

The management information is information indicating the current management conditions of the client's assets. The management information includes the master portfolio and virtual portfolios described with reference to FIG. 4. Additionally, the management information may also include information indicating the current achievability and an achievable time of the goal sum for each event.

### (Control Unit)

The control unit 240 controls the overall operation of the administration server 20. Particularly, as illustrated in FIG. 5, the control unit 240 according to the present embodiment is provided with an estimation unit 241, a display control unit 242, a plan creation unit 244, an administration unit 246, and a plan adjustment unit 248.

The estimation unit 241 estimates an event likely to occur in the future for the client. For example, the estimation unit 241 may estimate an event to occur in the future by referencing the age or gender of the client input by the client. In addition, on the basis of preset settings, the estimation unit 241 may also estimate information related to the goal sum, achievement time, and risk tolerance for every event. For example, for each event, information related to a risk tolerance as well as a goal sum and an achievement time may be set. The estimation unit 241 is able to estimate a goal sum, achievement time, and risk tolerance corresponding to an event estimated to occur in the future by referencing the above information preset for every event.

Note that the estimation unit 241 may also estimate an event occurring in the future by referencing the client information stored in the storage unit 230. For example, in the case in which the family structure included in the client information indicates the existence of a child, the estimation unit 241 estimates education expenses for the child's entrance into a university as an event occurring in the future. Additionally, the estimation unit 241 estimates a goal sum and a risk tolerance corresponding to the education expenses by referencing the information preset for every event. Also, in the case in which the age that the child will be when entering a university is set as the achievement time for the education expenses, the estimation unit 241 may also estimate the achievement time by computing the difference between the age of the child indicated by the client information and the age that the child will be when entering a university.

In addition, the estimation unit 241 may also estimate the replacement purchase of a car as an event occurring in the future from the car ownership information included in the client information. Additionally, the estimation unit 241 estimates a goal sum and a risk tolerance corresponding to the replacement purchase of a car by referencing the information preset for every event. Also, in the case in which the replacement purchase cycle is preset as the achievement time for the replacement purchase of a car, the estimation unit 241 may also estimate the achievement time by adding the above replacement purchase cycle to the car purchase time included in the client information.

The display control unit 242 generates a display screen for display on the client terminal 10. For example, the display control unit 242 generates an event settings screen, a plan display screen indicating the asset management plan, a display screen indicating the asset management conditions, and the like. Each display screen will be described later in “3. Details regarding display control”.

The plan creation unit 244 creates an asset management plan for each event, on the basis of the goal sum, the achievement time, and the risk tolerance for every event set by the client. The asset management plan is information about every event indicating an initial investment amount and a monthly contribution amount to each financial product. The creation of the asset management plan by the plan creation unit 244 will be described in detail in “4. Creation of asset management plan”.

The administration unit 246 administers the assets of the client according to the asset management plan created by the plan creation unit 244. For example, the administration unit 246 controls buy and sell orders to an external contract server in accordance with the asset management plan. Additionally, the administration unit 246 creates and updates a virtual portfolio for every event.

The plan adjustment unit 248 adjusts the initial asset management plan created by the plan creation unit 244 according to actual asset management conditions. For example, the plan adjustment unit 248 creates a new asset management plan for each event on the basis of the actual asset management conditions, and computes the difference between the initial investment amount into each financial product in the new asset management plan and the asset value of each financial product in the actual asset management conditions as an adjustment value. On the basis the adjustment value, the administration unit 246 controls buy and sell orders. This plan adjustment by the plan adjustment unit 248, or in other words rebalancing, will be described later in “5. Rebalancing”.

### 3. DETAILS REGARDING DISPLAY CONTROL

The above describes a configuration of the administration server 20 according to an embodiment of the present disclosure. Next, specific examples of the various display screens generated by the display control unit 242 of the administration server 20 will be described.

### (Event Settings Screen)

The display control unit 242 generates a settings screen by which the client sets event information. Hereinafter, an event selection screen and a goal setting screen will be described as specific examples of the event settings screen.

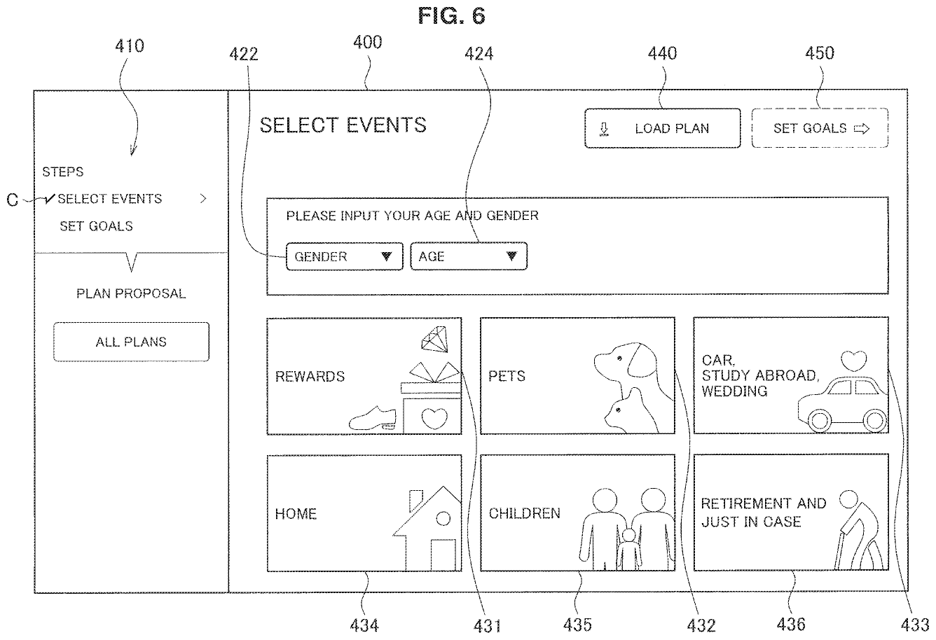

FIG. 6 is an explanatory diagram illustrating a specific example of an event selection screen 400. As illustrated in FIG. 6, the event selection screen 400 includes a progress display region 410, a gender input field 422, an age input field 424, event major category display sections 431 to 436, a Load Plan button 440, and a Set Goals button 450.

The progress display region 410 indicates each step until the creation of an asset management plan is finished, and the current step. In the example illustrated in FIG. 6, the progress display region 410 indicates “Select Events”, “Set Goals”, and “Plan Proposal” as each step until the creation of an asset management plan is finished, and “Select Events” denoted with a check mark C is the current step.

The gender of the client is input into the gender input field 422, while the age of the client is input into the age input field 424.

The event major category display sections 431 to 436 respectively correspond to major categories of events. For example, the event major category display section 431 corresponds to “Rewards”, the event major category display section 432 corresponds to “Pets”, the event major category display section 433 corresponds to “Car, Study Abroad, Wedding”, the event major category display section 434 corresponds to “Home”, the event major category display section 435 corresponds to “Children”, and the event major category display section 436 corresponds to “Retirement and Just In Case”.

The Load Plan button 440 is enabled in the case in which the client has created an asset management plan in the past by the functions of the present disclosure, and the created asset management plan has been saved. When the enabled Load Plan button 440 is selected, the display control unit 242 loads the created asset management plan, and displays the created asset management plan.

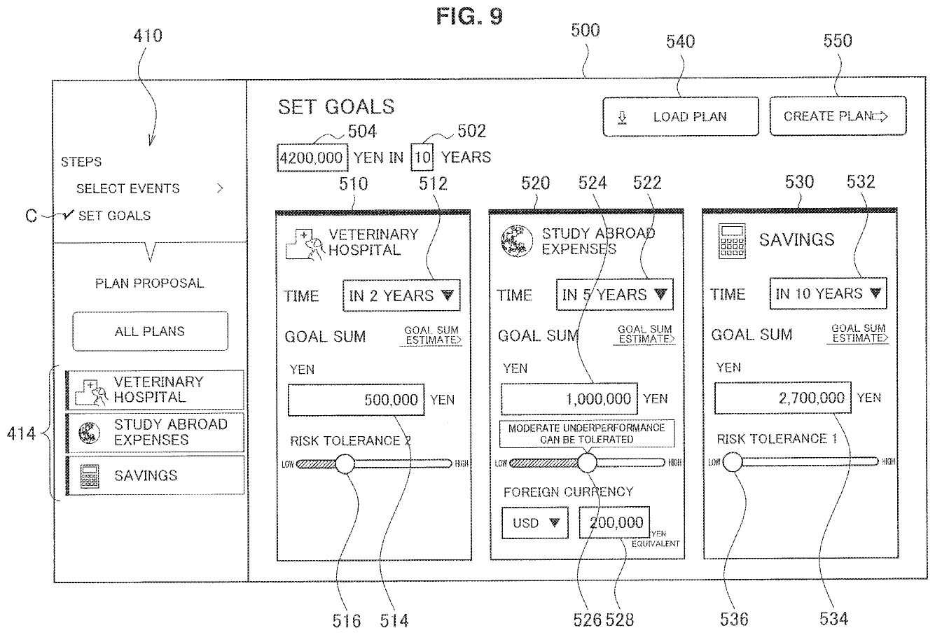

The Set Goals button 450 is enabled in the case in which at least one event has been selected. In the example illustrated in FIG. 6, since an event is not selected, the Set Goals button 450 is not enabled. When the enabled Set Goals button 450 is selected, the display control unit 242 generates a goal setting screen described later with reference to FIG. 9.

On such an event selection screen 400, if the client selects one of the event major category display sections, the display control unit 242 displays selection buttons for events belonging to the major category corresponding to the selected event major category display section.

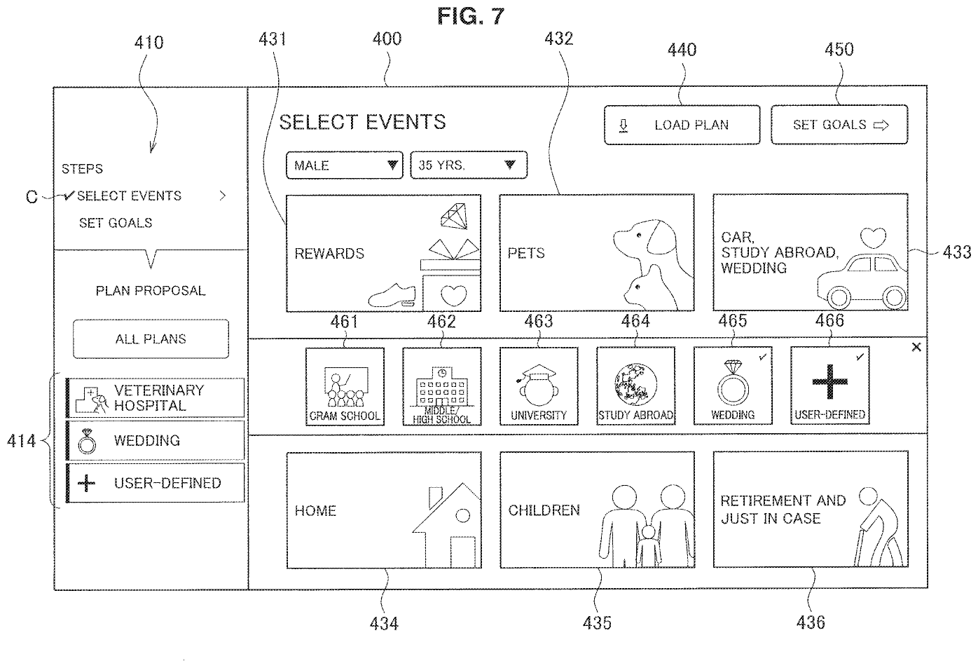

FIG. 7 is an explanatory diagram illustrating a specific example of event selection buttons. For example, if the event major category display section 435 corresponding to “Children” is selected by the client, as illustrated in FIG. 7, selection buttons for events belonging to the major category of “Children” are displayed. In FIG. 7, a selection button 461 corresponding to “Preparatory School”, a selection button 462 corresponding to “Middle/High School”, a selection button 463 corresponding to “University”, a selection button 464 corresponding to “Study Abroad”, a selection button 465 corresponding to “Wedding”, and a selection button 466 corresponding to “User-defined” are illustrated as selection buttons.

The client is able to select one or multiple events by selecting one or multiple selection buttons from among the selection button 461 to the selection button 465. In addition, the client is also capable of selecting events belongs to different major categories by successively selecting different event major category display sections. The events selected by the client are added to an event list 414 of the progress display region 410. Also, when events are selected by the client, the Set Goals button 450 is enabled as illustrated in FIG. 7.

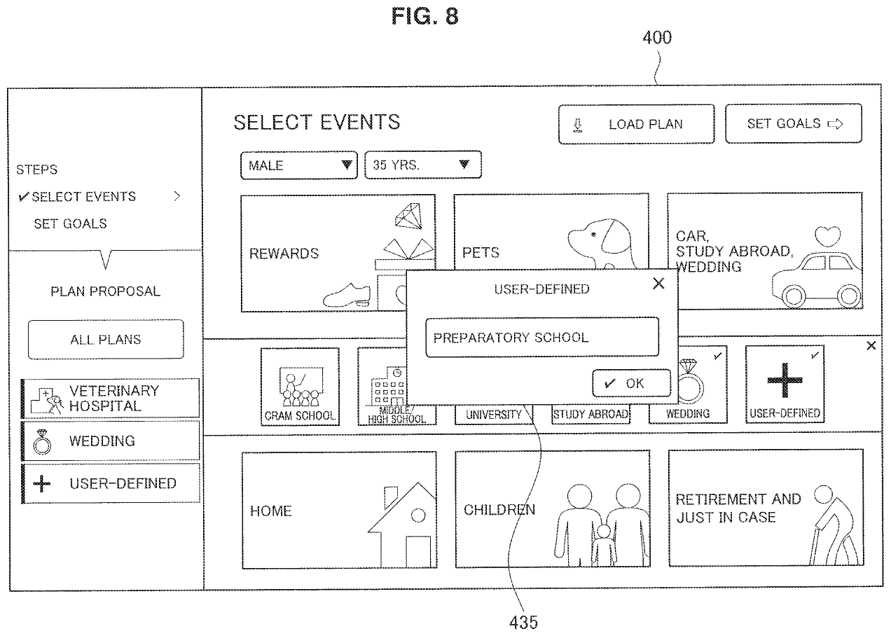

Note that in the case in which the selection button 466 corresponding to “User-defined” is selected by the client, as illustrated in FIG. 8, the display control unit 242 may overlay a window 470 for inputting an event name onto the event selection screen 400. According to such a configuration, the client is also capable of setting events not included in the predefined event groups.

Also, the selection buttons displayed when each event major category display section is selected may be shared in common among all clients, or may be different for every client. For example, the estimation unit 241 may estimate events that will occur in the future with respect to the client on the basis of the gender of the client input into the gender input field 422 and the age of the client input into the age input field 424, and the display control unit 242 may display selection buttons corresponding to the estimated events. Also, in the case in which client information indicating the client's family structure, insurance coverage, and the like is stored in the storage unit 230, the estimation unit 241 may also estimate events that will occur in the future with respect to the client on the basis of the client information.

When the Set Goals button 450 is selected after events have been selected by the client, the display control unit 242 generates a goal setting screen.

FIG. 9 is an explanatory diagram illustrating a specific example of a goal setting screen 500. As illustrated in FIG. 9, the goal setting screen 500 includes the progress display region 410, a years-to-achieve display section 502, a goal sum display section 504, goal setting regions 510 to 530, a Save button 540, and a Create Plan button 550.

On the goal setting screen 500, from among each of the steps included in the progress display region 410, “Set Goals” is denoted with the check mark C.

The years-to-achieve display section 502 displays the number of years until the latest achievement time arrives from among the goal achievement times of each of the events set in the goal setting regions 510 to 530. The goal sum display section 504 displays the total monetary amount of the goal sums for each of the events set in the goal setting regions 510 to 530.

The goal setting regions 510 to 530 are regions for setting event information such as the goal achievement time, the goal sum, and the risk tolerance of each event. For example, the goal setting region 510 includes an achievement time input field 512, a goal sum input field 514, and a slider 516 for setting the risk tolerance. In the achievement time input field 512 and the goal sum input field 514 values estimated by the estimation unit 241 are displayed, and these values may be corrected by the user as necessary. Note that by selecting “Goal Sum Estimate”, an estimate of the goal sum is displayed. Also, the goal setting region 520 corresponding to study abroad expenses includes an achievement time input field 522, an achievement time input field 522, and a slider 526, as well as a foreign currency goal sum input field 528.

The Save button 540 is a button for saving the set content on the goal setting screen 500. The Create Plan button 550 is a button for creating an asset management plan for each event. When the Create Plan button 550 is selected, the plan creation unit 244 creates an asset management plan for each event on the basis of the event information set on the goal setting screen 500, and the display control unit 242 generates a plan display screen indicating the created asset management plan.

### (Plan Display Screen)

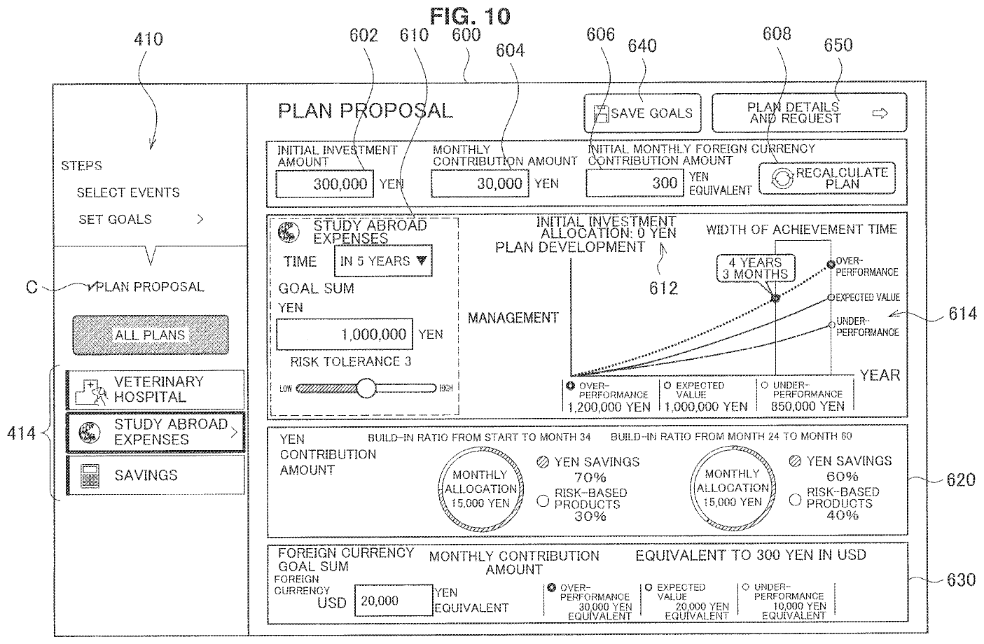

FIG. 10 is an explanatory diagram illustrating a specific example of a plan display screen 600. As illustrated in FIG. 10, the plan display screen 600 includes the progress display region 410, an initial investment amount display field 602, a contribution amount display field 604, a foreign currency contribution amount display field 606, a Recalculate button 608, an event information display region 610, an initial quota display field 612, a development prediction display 614, a contribution display region 620, a foreign currency display region 630, a Save button 640, and a Request button 650.

On the plan display screen 600, from among each of the steps included in the progress display region 410, “Plan Proposal” is denoted with the check mark C.

The initial investment amount display field 602 displays an initial investment amount included in the asset management plan. The contribution amount display field 604 displays a monthly contribution amount in yen included in the asset management plan. The foreign currency contribution amount display field 606 displays a monthly contribution amount in a foreign currency included in the asset management plan. On the plan display screen 600, the values in the initial investment amount display field 602, the contribution amount display field 604, and the foreign currency contribution amount display field 606 are adjustable, and when the Recalculate button 608 is selected, the plan creation unit 244 re-creates the asset management plan by recalculating with the adjusted values.

The event information display region 610 displays event information such as the goal sum, achievement time, and risk tolerance of an event. In FIG. 10, the display of an asset management plan for study abroad expenses is selected, and in the event information display region 610, event information about study abroad expenses is illustrated.

The initial quota display field 612 displays an initial investment amount allocated to the event from among the overall initial investment amount. In the example illustrated in FIG. 10, the initial investment amount allocated to study abroad expenses is 0 yen.

The development prediction display 614 displays a prediction of how assets will develop according to the created asset management plan. The development prediction display 614 includes an expected value line illustrated by the solid line in FIG. 10, as well an overperformance line illustrated by a dotted line, and an underperformance line illustrated by a chain line. According to such a configuration, the client is able to easily grasp the risk and return for each event under asset management according to the asset management plan. Note that the development prediction display 614 may also include a predicted value (in the example illustrated in FIG. 10, 4 years 3 months) of the time when the goal will be achieved in the case in which the asset development overperforms.

The contribution display region 620 includes a display indicating a monthly contribution amount allocated to the event, and the distribution of the contribution to each financial product or each financial product class. In the case in which the monthly contribution amount or the distribution of the contribution is different depending on the time period, the monthly contribution amount and the distribution of the contribution is displayed for every time period. The foreign currency display region 630 includes a display illustrating a goal sum and a monthly contribution amount of a foreign currency.

When another event on the event list 414 of the plan display screen 600 is selected, the display control unit 242 generates a plan display screen 600 displaying the asset management plan for the other event. Also, when “All Plans” is selected in the progress display region 410, the display control unit 242 displays a combined result of the asset management plans for all events.

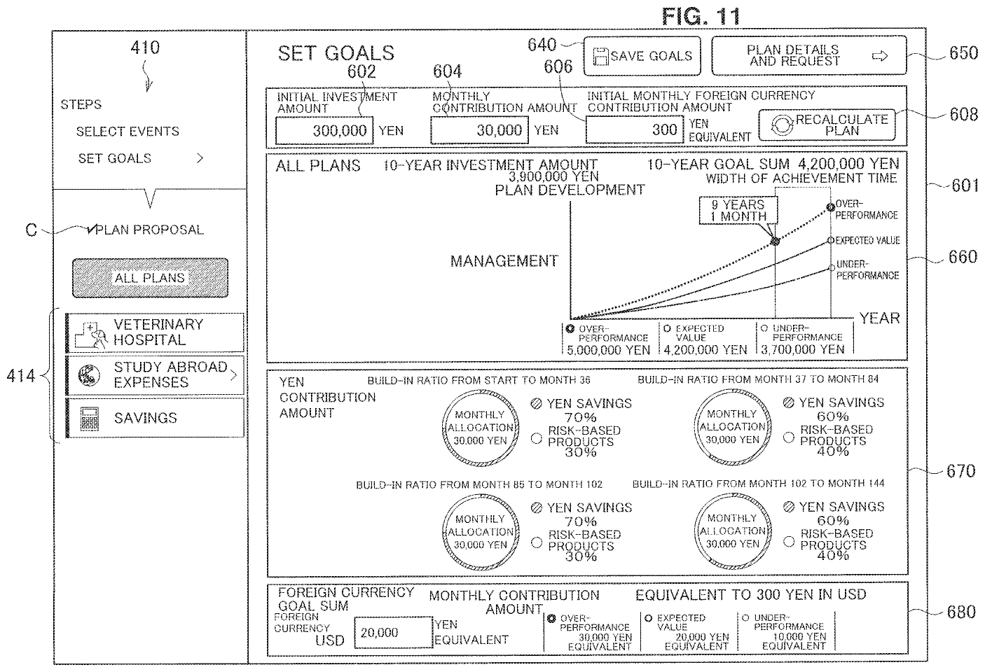

FIG. 11 is an explanatory diagram illustrating a specific example of a plan display screen 601 that displays a combined result of the asset management plans for all events. As illustrated in FIG. 11, the plan display screen 601 includes the progress display region 410, the initial investment amount display field 602, the contribution amount display field 604, the foreign currency contribution amount display field 606, the Recalculate button 608, the Save button 640, the Request button 650, an overall development prediction display 660, an overall contribution display region 670, and an overall foreign currency display region 680.

Similarly to the plan display screen 600 for each event, the overall development prediction display 660 includes an expected value line illustrated by a solid line, as well an overperformance line illustrated by a dotted line, and an underperformance line illustrated by a chain line. According to such a configuration, the client is able to easily grasp the overall risk and return of the asset management according to the asset management plan.

The overall contribution display region 670 includes a display indicating a total monthly contribution amount, and the distribution of the contribution to each financial product or each financial product class. In the case in which the total contribution amount or the distribution of the contribution is different depending on the time period, the total contribution amount and the distribution of the contribution is displayed for every time period. The overall foreign currency display region 680 includes a display illustrating an overall goal sum and a total monthly contribution amount of a foreign currency.

When the Save button 640 is selected on the plan display screen 600 or the plan display screen 601 described above, the asset management plan is saved. Also, when the Request button 650 is selected, the display control unit 242 generates a purchase request screen for requesting the purchase of financial products in accordance with the asset management plan.

### (Purchase Request Screen)

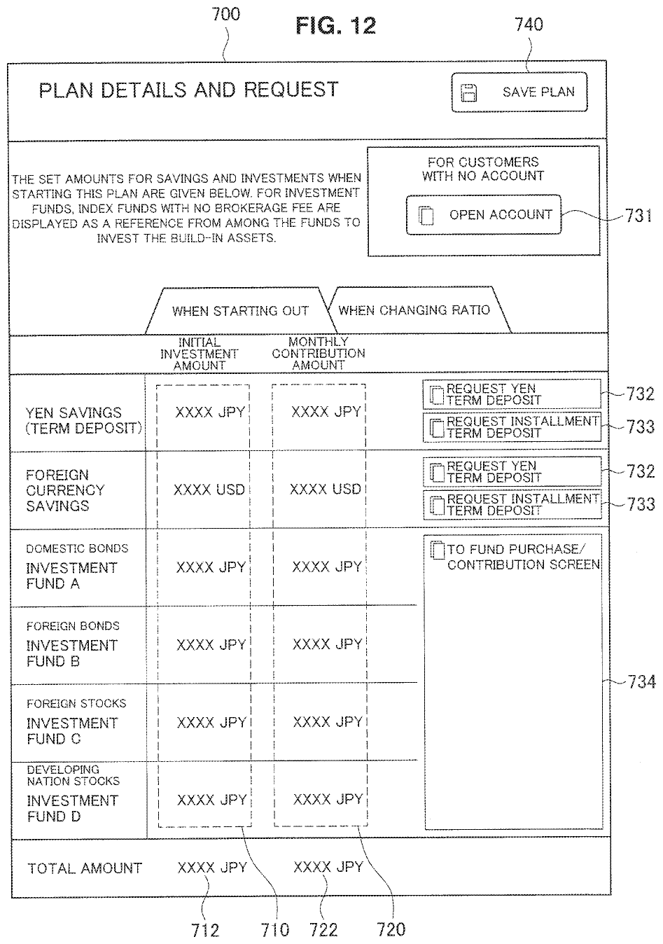

FIG. 12 is an explanatory diagram illustrating a specific example of a purchase request screen 700. As illustrated in FIG. 12, the purchase request screen 700 includes an initial investment amount display 710 for each financial product, an initial investment total amount display 712, a monthly contribution amount display 720 for each financial product, a monthly contribution amount total display 722, an Open Account button 731, a Request Yen Term Deposit button 732, a Request Installment Term Deposit button 733, a Request Investment Fund button 734, and a Save button 740.

When the Open Account button 731 is selected, a web page for opening an account is displayed. When the Request Yen Term Deposit button 732, a web page for requesting a yen term deposit is displayed. When the Request Installment Term Deposit button 733 is selected, a web page for requesting an installment term deposit is displayed. When the Request Investment Fund button 734 is selected, a web page for requesting an investment fund is displayed. When the Save button 740 is selected, the asset management plan is saved.

Through this purchase request screen 700, the client is able to accurately grasp the breakdown of the initial investment amounts and monthly contribution amounts for each financial product. Additionally, it is also possible to easily transition to web pages for requesting financial products.

### (Management Conditions Display Screen)

After asset management according to an asset management plan is started, the display control unit 242 generates a management conditions display screen illustrating the actual asset management conditions.

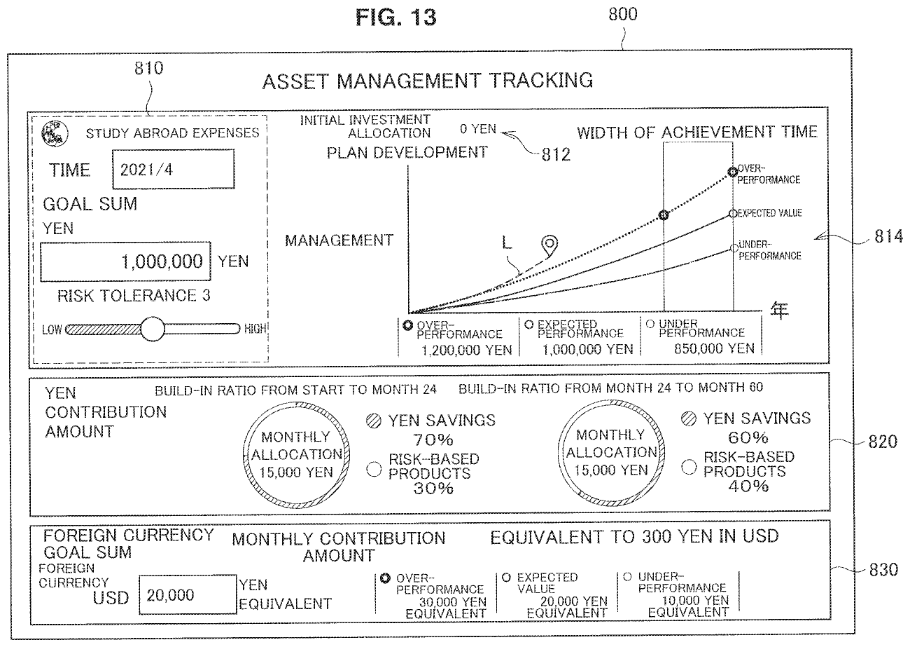

FIG. 13 is an explanatory diagram illustrating a specific example of a management conditions display screen 800. As illustrated in FIG. 13, the management conditions display screen 800 includes an event information display region 810, an initial quota display field 812, an asset development display 814, a contribution display region 820, and a foreign currency display region 830. The event information display region 810, the initial quota display field 812, the contribution display region 820, and the foreign currency display region 830 largely correspond to the event information display region 610, the initial quota display field 612, the contribution display region 620, and the foreign currency display region 630 described with reference to FIG. 10.

The asset development display 814 includes an expected value line and lines indicating the range of performance, as well as a line L indicating the development of the assets contributed for an event. By comparing the line L to the expected value line, the client is able to easily grasp whether or not the management conditions are favorable. Note that the asset development display 814 may also include a display illustrating the current achievability of the goal sum.

As the management conditions display screen 800, the display control unit 242 is capable of generating a display screen illustrating the management conditions for each event described with respect to FIG. 13, as well as generating a display illustrating a display screen illustrating the management conditions as a whole (the master portfolio).

Meanwhile, since the purchased financial products or the distribution of financial products is different for each event, differences may appear in the management conditions for each event. For example, there may be an event whose current valuation has risen above the expected value line, and another event whose current valuation has fallen below the expected value line. In such a case, according to a certain perspective, it is desirable to smooth out the management conditions of each event.

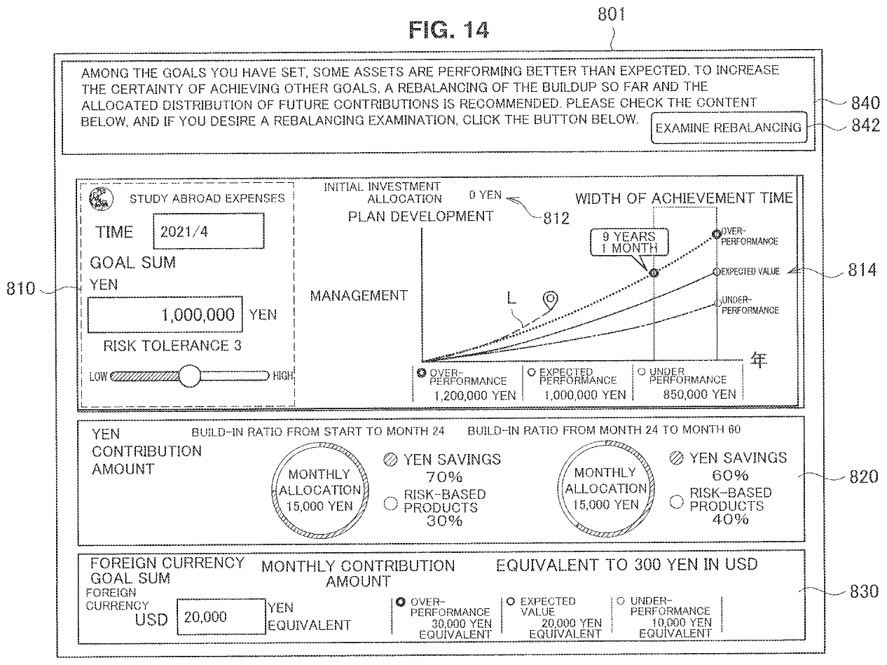

Accordingly, in the case in which the variation in the management conditions of each event has risen above a determination criterion, for example, as illustrated in FIG. 14, the display control unit 242 may generate a management conditions display screen 801 onto which a display 840 that proposes a rebalancing of the asset management plan is overlaid.

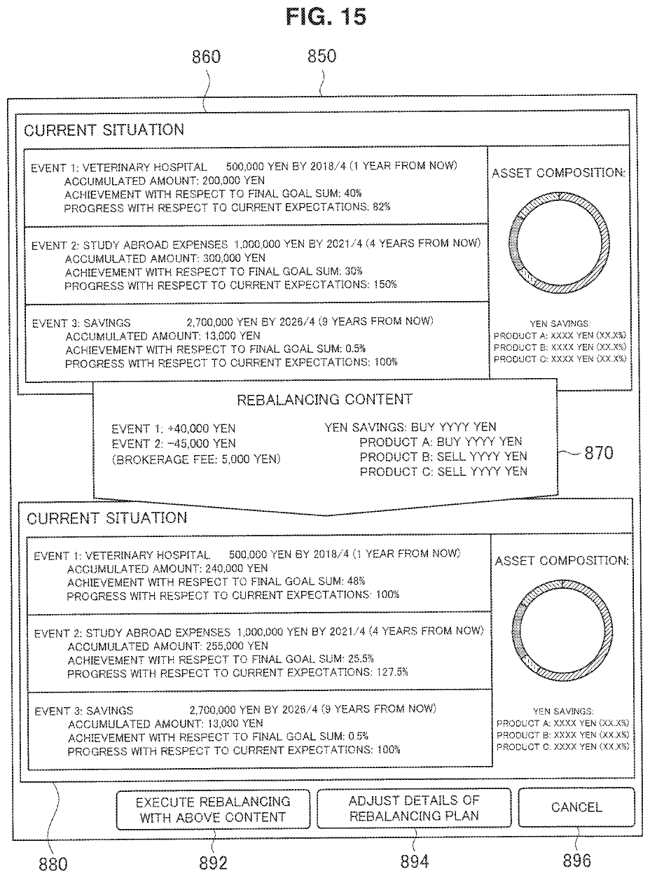

On the management conditions display screen 801, when an Examine button 842 included in the display 840 is selected, the plan adjustment unit 248 computes rebalancing content (adjustment values). Additionally, the display control unit 242 generates a rebalancing screen that includes the rebalancing content computed by the plan adjustment unit 248. Hereinafter, a specific example of a rebalancing screen will be described with reference to FIG. 15.

### (Rebalancing Screen)

FIG. 15 is an explanatory diagram illustrating a specific example of a rebalancing screen 850. As illustrated in FIG. 15, the rebalancing screen 850 includes a current conditions display 860 that illustrates the current asset management conditions, a rebalancing display 870 that illustrates rebalancing content, a result display 880 that illustrates a rebalancing result, an Execute button 892, a Fine Adjust button 894, and a Cancel button 896.

The current conditions display 860 illustrates, for each event, the amount accumulated up to the present, the current achievement with respect to the final goal sum, and the progress given the current expectations.

The rebalancing display 870 illustrates asset adjustment amounts for every event, as well as buy and sell amounts for each financial product. In the example illustrated in FIG. 15, in the example illustrated in FIG. 15, since the progress of Event 1 is 82% whereas the progress of Event 2 is 150%, a rebalancing that involves moving assets from Event 2 to Event 1 is illustrated. Note that moving assets may involve the buying and selling of financial products, such as the selling of a financial product accumulated for a source event, or the purchase of a new financial product and the allocation of the new financial product to the destination event. For this reason, the rebalancing display 870 may also include a display illustrating buy and sell amounts for each financial product as illustrated in FIG. 15.

The result display 880 illustrates what kind of result will be obtained as the asset conditions for each event in the case in which the rebalancing is executed. In the example illustrated in FIG. 15, the progress of the rebalanced Event 1 is 100%, and the progress of the rebalanced Event 2 is 127.5%.

When the Execute button 892 is selected, the plan adjustment unit 248 executes rebalancing with the content illustrated on the rebalancing screen 850. When the Fine Adjust button 894 is selected, the display control unit 242 generates a screen by which the client adjusts the rebalancing content. When the Cancel button 896 is selected, the display control unit 242 re-generates the screen that had been displayed before the rebalancing screen 850.

In this way, according to the present embodiment, since specific content of rebalancing is proposed from the system side, the burden on the client is reduced compared to the case in which the client computes the rebalancing content by oneself. In addition, since the rebalancing content and the rebalancing result can be confirmed before the rebalancing is executed, the client becomes able to appropriately judge whether or not to execute rebalancing.

### (Application 1)

The above describes an example in which the plan display screen 600 described with reference to FIG. 10 and the like is displayed after the goal setting screen 500 described with reference to FIG. 9. However, the adjustment screen 900 described below may also be displayed between the goal setting screen 500 and the plan display screen 600.

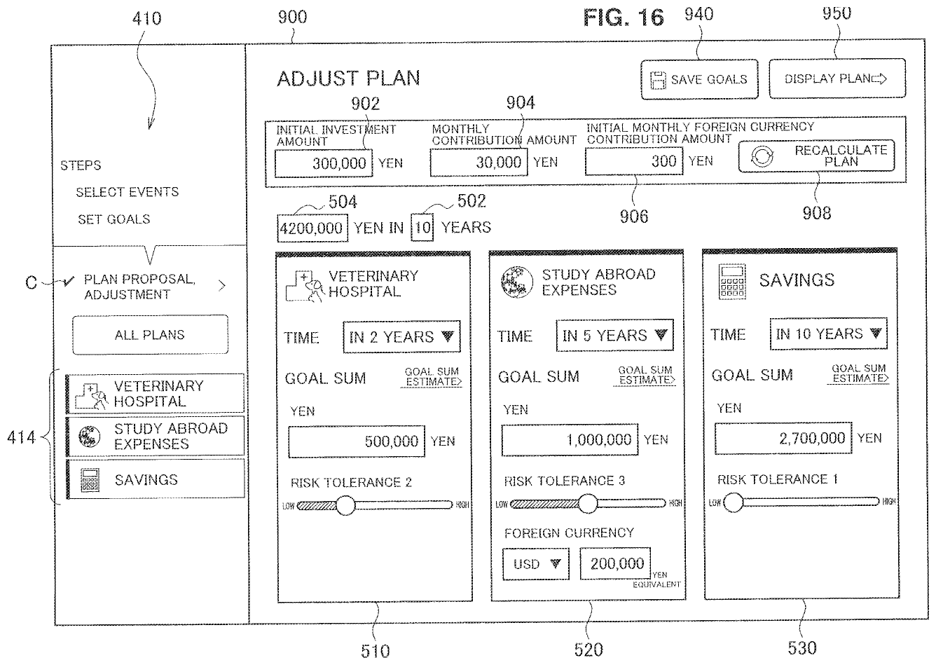

FIG. 16 is an explanatory diagram illustrating a specific example of the adjustment screen 900. As illustrated in FIG. 16, the adjustment screen 900 includes the progress display region 410, the goal setting regions 510 to 530, an initial investment amount display field 902, a contribution amount display field 904, a foreign currency contribution amount display field 906, a Recalculate button 908, a Save button 940, and a Display Plan button 950.

On the adjustment screen 900, from among each of the steps included in the progress display region 410, “Plan Proposal, Adjustment” is denoted with the check mark C.

The initial investment amount display field 602 displays the initial investment amount included in the asset management plan created by the plan creation unit 244. The contribution amount display field 604 displays a monthly contribution amount in yen included in the asset management plan. The foreign currency contribution amount display field 606 displays a monthly contribution amount in a foreign currency included in the asset management plan. The Save button 940 is a button for saving the set content on the adjustment screen 900. The Display Plan button 950 is a button for displaying a more specific plan display screen 600.

In the goal setting regions 510 to 530, the client is able to adjust the goal sum or the achievement time of each event, for example. When the client selects Recalculate button 908 after adjusting the goal sum or the achievement time, the plan creation unit 244 re-creates an asset management plan, and the monetary amounts in the initial investment amount display field 902, the contribution amount display field 904, and the foreign currency contribution amount display field 906 are updated. Also, in the initial investment amount display field 902 or the contribution amount display field 904, the client is able to adjust the initial investment amount or the contribution amount. When the client selects Recalculate button 908 after adjusting the initial investment amount or the contribution amount, the plan creation unit 244 re-creates an asset management plan, and the monetary amount in the initial investment amount display field 902, the contribution amount display field 904, or the foreign currency contribution amount display field 906 is updated.

According to such a configuration, on the adjustment screen 900, the client is able to match the initial investment amount and the contribution amount to one's own sensibilities. Consequently, on the plan display screen 600, it becomes possible to display an asset management plan matched to the client's sensibilities.

Note that the goal setting regions 510 to 530 may also include a display of the quota of the initial investment amount and the monthly contribution amount to the corresponding event, such that the quota of the initial investment amount and the monthly contribution amount are adjustable for every event on the display. According to such a configuration, the client becomes able to adjust the asset management plan in finer detail. Also, each of the goal setting regions 510 to 530 may include a Recalculate button. In this case, the client becomes able to repeatedly adjust the goal sum, achievement time, or risk tolerance of a certain event and select the Recalculate button more easily.

### (Application 2)

In some cases, the client does not go all the way to the purchase of the asset management plan created by the plan creation unit 244, and instead saves the asset management plan and temporarily ends use of the system of the present disclosure. After that, in the case in which the client accesses the system of the present disclosure, the display control unit 242 may display the saved asset management plan. According to such a configuration, the time and effort of the client setting event information and the like again is reduced.

Furthermore, the display control unit 242 may generate a display screen illustrating what kind of asset conditions would have been obtained hypothetically if asset management according to the asset management plan had been started at the time of creating the asset management plan. The display screen may also include a display illustrating how assets would have developed hypothetically if asset management according to the asset management plan had been started at the time of creating the asset management plan, like the management conditions display screen 800 described with reference to FIG. 13.

By illustrating the usefulness of the asset management plan to the client on the display screen, it is possible to arouse interest in requesting asset management according to the asset management plan.

### 4. CREATION OF ASSET MANAGEMENT PLAN

The above describes specific examples of the various display screens generated by the display control unit 242. Next, an asset management plan creation method will be described. Note that it should be understood that a variety of asset management plan creation methods are conceivable, and the asset management plan creation method described below is one example of the variously conceivable asset management plan creation methods.

### (Basic Concept)

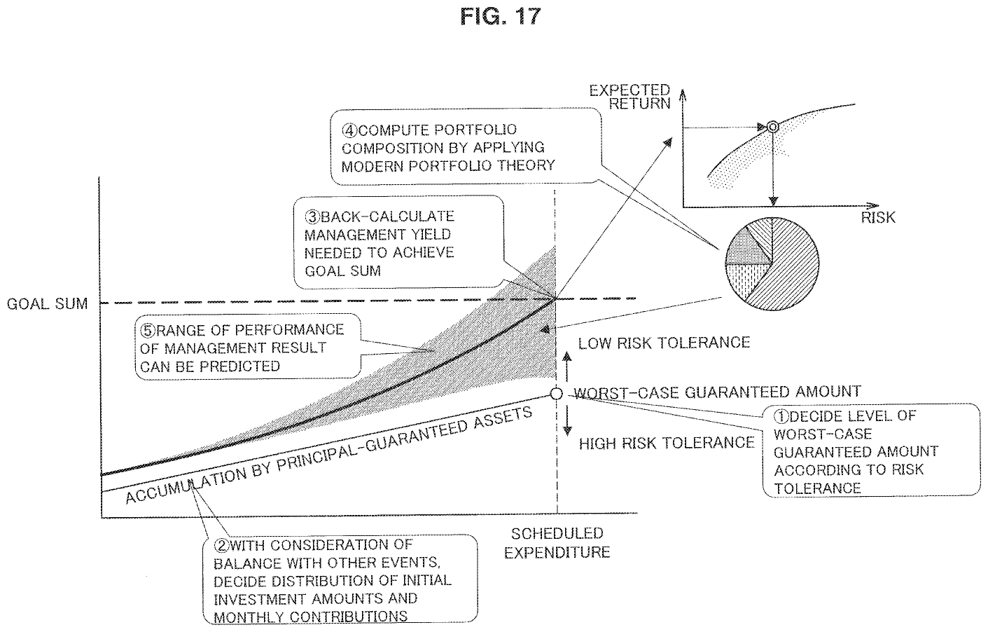

FIG. 17 is an explanatory diagram illustrating the basic concept of a certain asset management plan creation method. First, the plan creation unit 244 decides a worst-case guaranteed amount (a lower limit amount that should be secured) according to the risk tolerance set for an event. Subsequently, and with consideration of the balance with other events, the plan creation unit 244 decides an allocation of initial investment amounts and contribution amounts to principal-guaranteed financial products and risk-based financial products, such that the lower limit amount is secured by the principal-guaranteed financial products). The allocation of initial investment amounts and contribution amounts to principal-guaranteed financial products and risk-based financial products decided here is also designated a contribution plan.

Furthermore, on the basis of the allocation of initial investment amounts and contribution amounts, the plan creation unit 244 computes the necessary managed yield for achieving the goal sum of the event, and decides a portfolio composition (a combination and distribution of financial products) for realizing the managed yield on the basis of modern portfolio theory, for example. With this arrangement, it is also possible to predict the range of performance for assets in actual management.

### (Logic 1)

The plan creation unit 244 is able to create an asset management plan from a state with no specification of initial investment amounts and contribution amounts. To make the description of the creation method easy to understand, first, the logic (hereinafter, Logic 1) used to decide a contribution plan in the case in which a contribution amount is specified will be described.

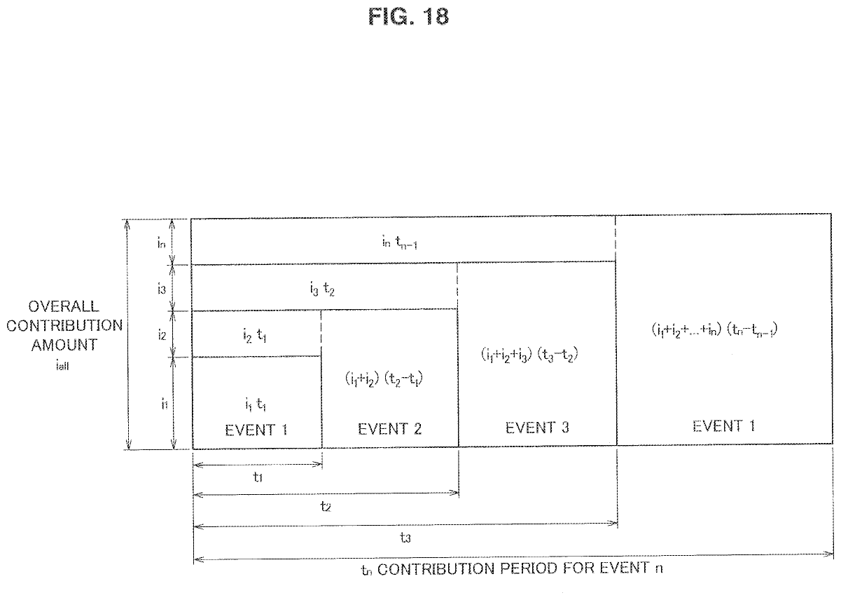

FIG. 18 is an explanatory diagram illustrating the concept of contribution amounts every period for each event. As illustrated in FIG. 18, contributed money is allocated to all events during a period t₁ until the achievement time of Event 1 arrives, while contributed money is allocated to Events 2 to n during a period (t₂−t₁) from the achievement time of Event 1 until the achievement time of Event 2, and contributed money is allocated only to Event n during a period (tₙ−tₙ₋₁) from the achievement time of Event n−1 until the achievement time of Event n. Note that iₙ in FIG. 18 is the contribution amount at the start of management to Event n, while iₐₗₗ is the overall contribution amount. Hereinafter, the creation of a contribution plan according to Logic 1 will be described specifically.

Contribution Plan for Event n

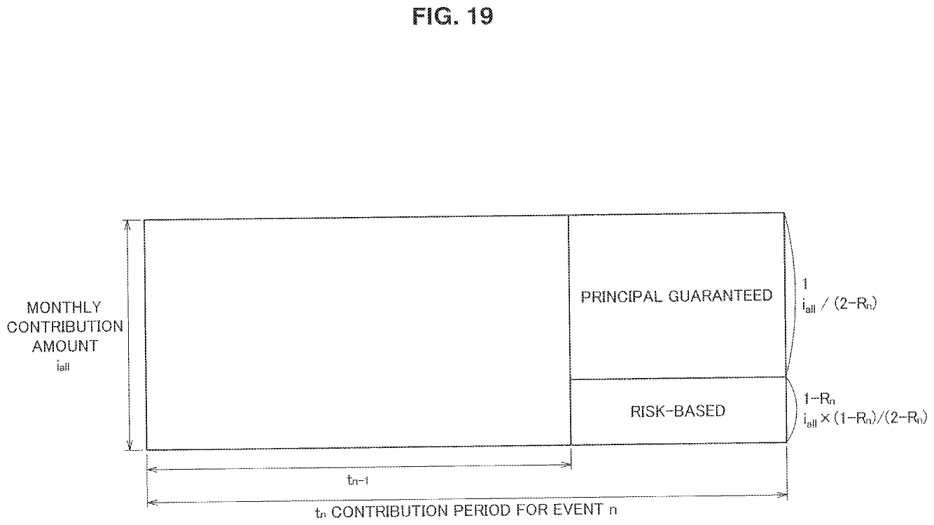

FIGS. 19 to 23 are explanatory diagrams illustrating the process of creating a contribution plan according to Logic 1. First, the plan creation unit 244 performs allocation for the period (tₙ−tₙ₋₁) of the Event n having the latest achievement time. Specifically, the plan creation unit 244 specifies a minimum achievement rate Rₙ (a value from 0 to 1) corresponding to the risk tolerance of Event n, and as illustrated in FIG. 19, for the period (tₙ−tₙ₋₁), distributes the overall contribution amount iₐₗₗ among principal-guaranteed financial products and risk-based financial products according to the ratio (1:1−Rₙ). Therefore, the accumulated amount Nₙ of the contribution amounts distributed to principal-guaranteed financial products for Event n in the above period (tₙ−tₙ₋₁) is expressed as (tₙ−tₙ₋₁)iₐₗₗ/(2−Rₙ).

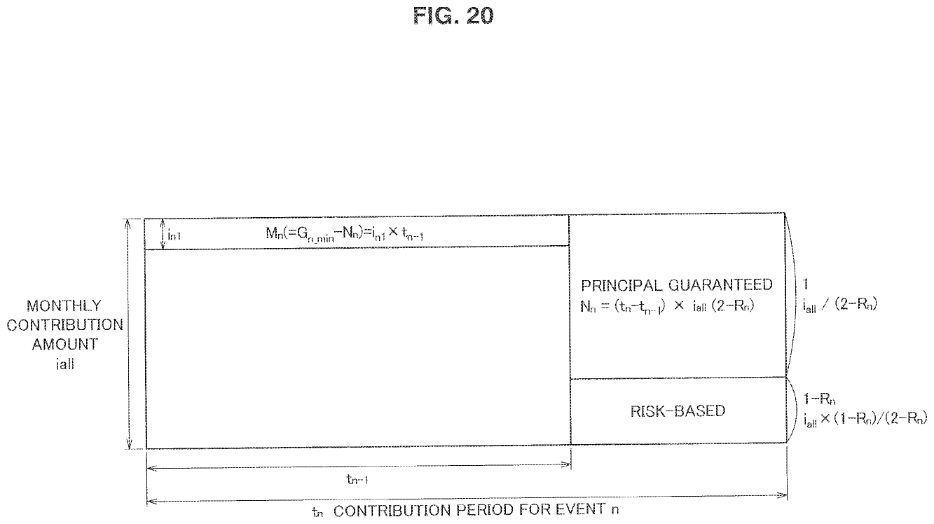

Next, the plan creation unit 244 computes the contribution amount to allocate to principal-guaranteed financial products for Event n in the period (tₙ₋₁). Specifically, the plan creation unit 244 computes a lower limit amount Gₙₘᵢₙ by multiplying the minimum achievement rate Rₙ by the goal sum of Event n, and as illustrated in FIG. 20, computes Gₙₘᵢₙ−Nₙ to compute an accumulated amount Mₙ of the contribution amounts to be allocated to principal-guaranteed financial products for Event n in the period (tₙ₋₁). Subsequently, the plan creation unit 244 computes Mₙ/(tₙ₋₁) to compute a monthly contribution amount iₙ₁ to allocate to principal-guaranteed financial products for Event n in the period (tₙ₋₁).

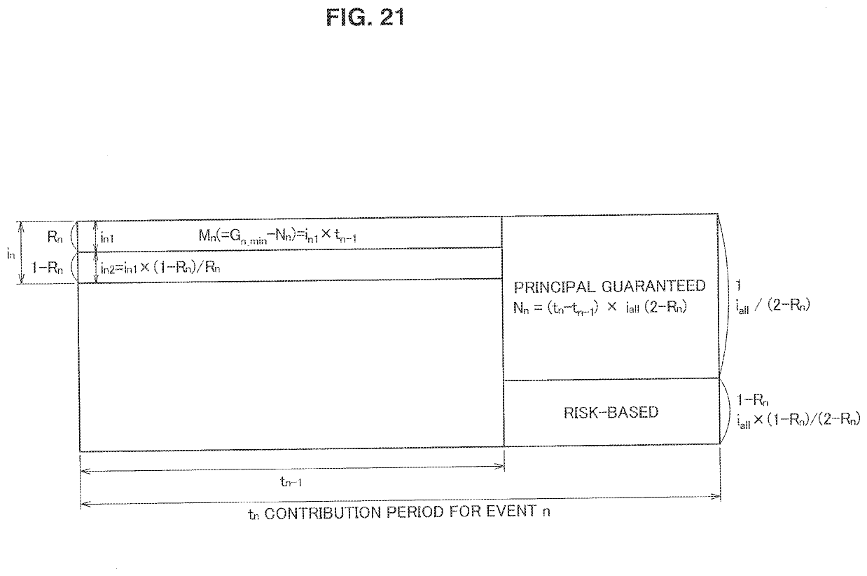

Additionally, the plan creation unit 244 computes a contribution amount iₙ₂ to allocate to risk-based financial products for Event n in the period (tₙ₋₁). Specifically, as illustrated in FIG. 21, the plan creation unit 244 computes a contribution amount iₙ₂ to allocate to risk-based financial products for Event n in the period (tₙ₋₁) such that (iₙ₁:iₙ₂)=(Rₙ:1−Rₙ). For this reason, the sum total iₙ of the contribution amounts for Event n in the period (tₙ₋₁) is obtained by computing (iₙ₁+iₙ₂). By the process thus far, the derivation of a contribution plan for Event n ends.

Herein, the difference between the accumulated amount of the contribution amounts allocated to principal-guaranteed financial products and the goal sum for Event n according to the above method becomes equal to or greater than the accumulated amount of the contribution amounts allocated to risk-based financial products for Event n. In other words, the accumulated amount of the contribution amounts allocated to Event n may be a value less than the goal sum of Event n. However, since the contributed assets receive profit according to the managed yield, it is anticipated that the insufficiency with respect to the goal sum will be compensated for by the asset increase due to the managed yield. Rather, a difference between the accumulated amount of the contribution amounts allocated to Event n and the goal sum of Event n is provided deliberately in anticipation of asset increase due to the managed yield.

Contribution Plan from Event n−1 to Event 2

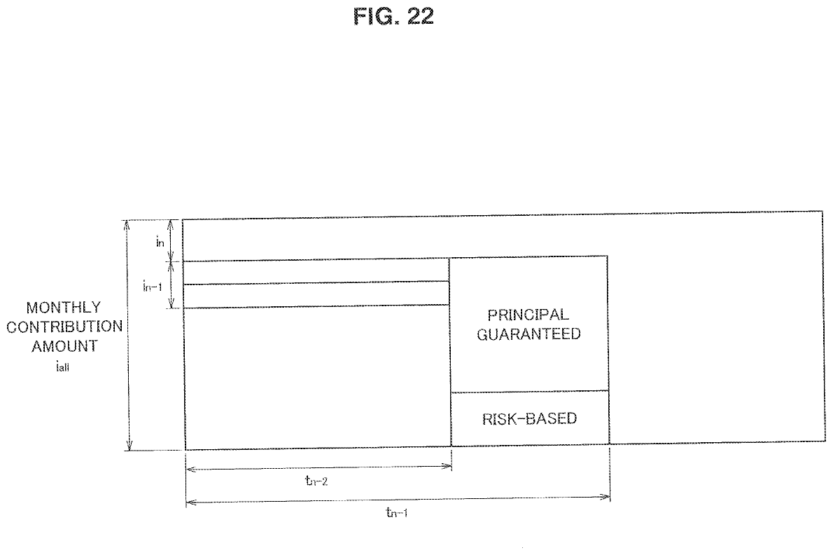

Next, as illustrated in FIG. 22, the plan creation unit 244 executes the allocation of contribution amounts for Event n−1 by a process of substituting the overall contribution amount iₐₗₗ with (iₐₗₗ−iₙ) in the description of allocation for Event n. Furthermore, the plan creation unit 244 derives a contribution plan up to Event 2 by recursively repeating this process up to the allocation for Event 2.

Contribution Plan for Event 1

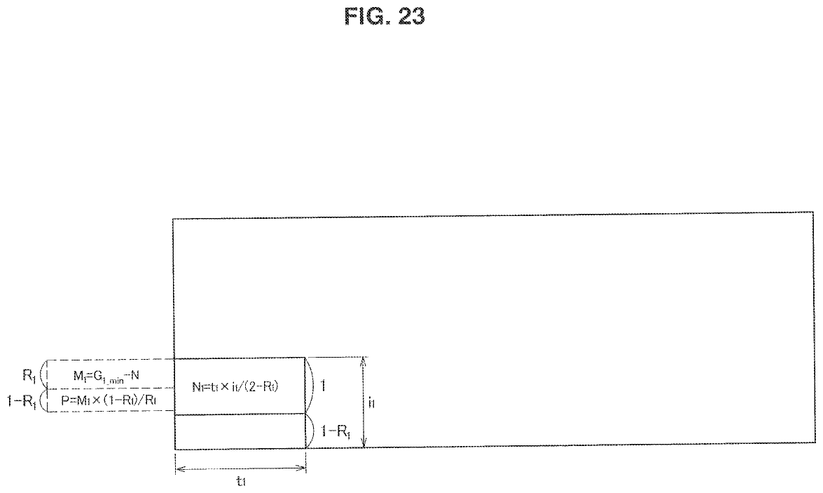

By the derivation of a contribution plan up to Event 2, the contribution amounts i₂ to iₙ for each of Events 2 to n are specified, and thus the plan creation unit 244 is able to compute the contribution amount i₁ for Event 1 by subtracting the contribution amounts i₂ to iₙ from the overall contribution amount iₐₗₗ. Additionally, the plan creation unit 244 specifies a minimum achievement rate R₁ (a value from 0 to 1) corresponding to the risk tolerance of Event 1, and as illustrated in FIG. 23, and distributes the contribution amount i₁ among principal-guaranteed financial products and risk-based financial products according to the ratio (1:1−R₁). Therefore, the accumulated amount N₁ of the contribution amounts distributed to principal-guaranteed financial products for Event 1 in the period (t₁) is expressed as (t₁)i₁/(2−R₁).

Additionally, the plan creation unit 244 computes a lower limit amount G₁ₘᵢₙ by multiplying the minimum achievement rate R₁ by the goal sum of Event 1, and as illustrated in FIG. 23, computes the difference M₁ between G₁ₘᵢₙ and N₁ as the initial investment amount into principal-guaranteed financial products for Event 1.

Additionally, the plan creation unit 244 computes an initial investment amount P into risk-based financial products for Event 1. Specifically, the initial investment amount P into risk-based financial products is computed such that (M₁:P)=(R₁:1−R₁). With this arrangement, the derivation of a contribution plan for Event 1 also ends.

### (Operation Flows)

The above describes a method of creating a contribution plan in the case in which a contribution amount is specified, in order to understand the asset management plan creation method according to an embodiment of the present disclosure. Next, a flow of operations by the present embodiment that creates a contribution plan and an asset management plan from a state with no specification of initial investment amounts and contribution amounts will be described.

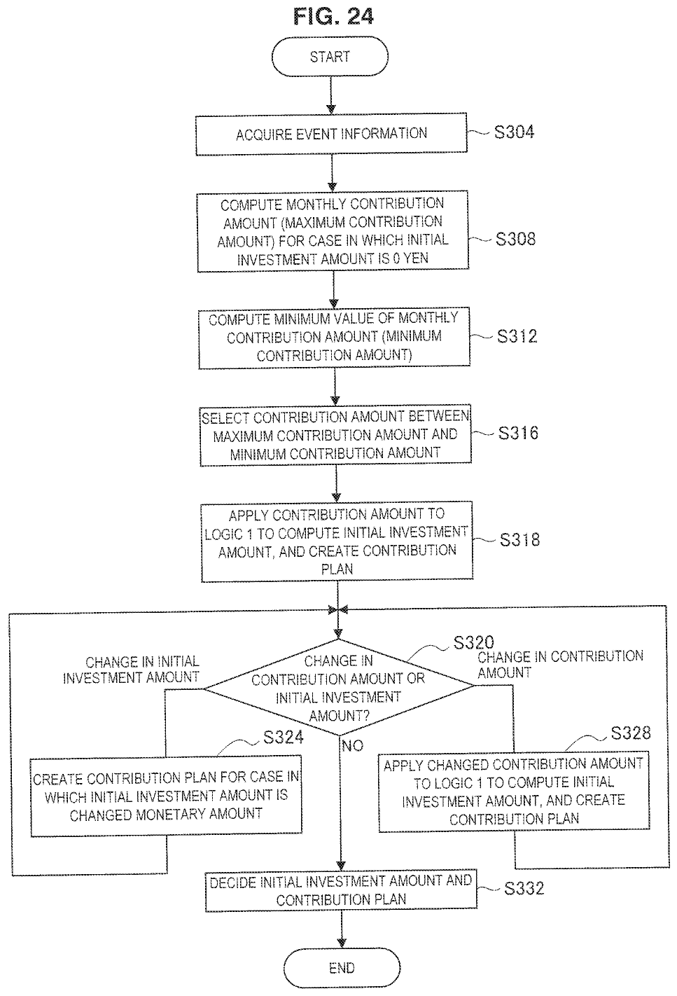

FIG. 24 is a flowchart illustrating a method of creating a contribution plan according to an embodiment of the present disclosure. As illustrated in FIG. 24, first, if the communication unit 220 acquires event information from the client terminal 10 (S304), the plan creation unit 244 computes a monthly contribution amount for the case in which the initial investment amount is 0 yen (S308). For example, the plan creation unit 244 may execute Logic 1 by applying various values as the monthly contribution amount, and compute the contribution amount at which the initial investment amount becomes 0 yen as the solution. Alternatively, the plan creation unit 244 may compute the monthly contribution amount for the case in which the initial investment amount is 0 yen by executing Logic 1 in reverse direction with the initial investment amount set to 0 yen. Note that the monthly contribution amount for the case in which the initial investment amount is 0 yen is the maximum contribution amount within the range of settable contribution amounts.

Also, the plan creation unit 244 computes a minimum value (minimum contribution amount) of the monthly contribution amount (S312). For example, the plan creation unit 244 computes the monthly contribution amount for the case in which the goal sum of the event with the earliest achievement time is the initial investment amount. Specifically, Logic 1 may be executed by applying various values as the monthly contribution amount, and the contribution amount at which the initial investment amount becomes the above goal sum may be computed as the solution. Alternatively, the plan creation unit 244 may compute the monthly contribution amount for the case in which the initial investment amount is the above goal sum by executing Logic 1 in reverse direction with the initial investment amount set to the above goal sum. Note that the plan creation unit 244 may also compute the monthly contribution amount for the case in which not the goal sum of the event with the earliest achievement time, but instead a predetermined ratio (for example, 40%) of the total amount of the goal sums for each event, is the initial investment amount.

Subsequently, the plan creation unit 244 selects a monthly contribution amount within the range between the maximum contribution amount computed in S308 and the minimum contribution amount computed in S312 (S316), and by applying the selected monthly contribution amount to Logic 1, computes the initial investment amount and creates a contribution plan for each event (S318).

After that, the monthly contribution amount selected in S316 and the initial investment amount computed in S318 are transmitted to the client, and the monthly contribution amount and the initial investment amount are confirmed by the client. Herein, if the client performs an operation of changing the initial investment amount (S320/change in initial investment amount), the plan creation unit 244 creates a contribution plan for the case in which the initial investment amount is the changed monetary amount (S324). On the other hand, if the client performs an operation of changing the contribution amount (S320/change in contribution amount), the plan creation unit 244 applies the changed contribution amount to compute the initial investment amount, and creates a contribution plan for each event (S328). In the case in which no change is made to either the contribution amount or the initial investment amount, the plan creation unit 244 decides the initial investment amount and the contribution plan (S332).

Next, on the basis of the decided initial investment amount and contribution plan, the plan creation unit 244 creates for every event an asset management plan that indicates the initial investment amount and the monthly contribution amount to each financial product.

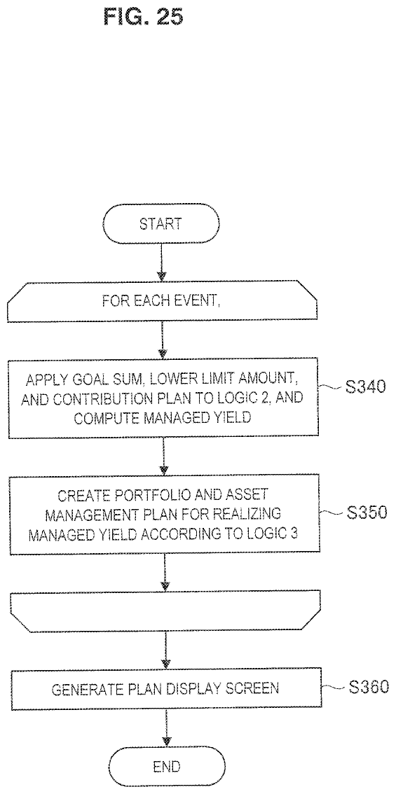

FIG. 25 is a flowchart illustrating the flow of creating an asset management plan from a contribution plan. For every event, the plan creation unit 244 creates an asset management plan by executing the processes illustrated in S340 and S350.

In other words, by applying the contribution plan, goal sum, and lower limit amount (the monetary amount ensured by principal-guaranteed financial assets) to Logic 2, the plan creation unit 244 computes the managed yield for achieving the goal sum (S340). For example, following Logic 2, the plan creation unit 244 computes the managed yield for achieving the goal sum from the relationship between the insufficiency of the lower limit amount with respect to the goal sum and the accumulated amount of the contribution amounts allocated to risk-based financial products. Note that the managed yield computed by the plan creation unit 244 may also be the managed yield obtained by risk-based financial products. Also, the achievement of the goal sum above may also be the achievement of the goal sum by the after-tax assets obtained by selling the financial products.

Next, the plan creation unit 244 creates a portfolio and an asset management plan for realizing the managed yield computed in S340 in accordance with Logic 3 (S350). For example, the plan creation unit 244 follows Logic 3 to create a portfolio of financial products (a combination of financial products and the distribution to each financial product) using modern portfolio theory, for example, from existing information such as the expected yield and expected risk for each financial product as well as the correlation with other financial product classes, and the managed yield computed in S340.

Additionally, the plan creation unit 244 creates an asset management plan indicating the initial investment amount and monthly contribution amount to each financial product by breaking up the contribution amount to risk-based financial products, the contribution amount to principal-guaranteed financial products, and the initial investment amount in the contribution plan according to the distribution indicated by the portfolio.

When the processes in S340 and S350 are finished for all events, and asset management plans are created for all events, the display control unit 242 generates a plan display screen indicating the asset management plan for each event (S360). By transmitting the plan display screen to the client terminal 10, and displaying the plan display screen on the client terminal 10, the client is able to grasp specifically what kind of asset management should be carried out for every event to achieve the goal sum for each event.

### (Modifications)

FIG. 18 illustrates an example in which, as the model for creating a contribution plan, the sum total of the contribution amounts for Event 1 to Event n−1 is fixed over the period tₙ₋₁ until the achievement time of Event n−1 arrives, but the model for creating a contribution plan is not limited to such an example.

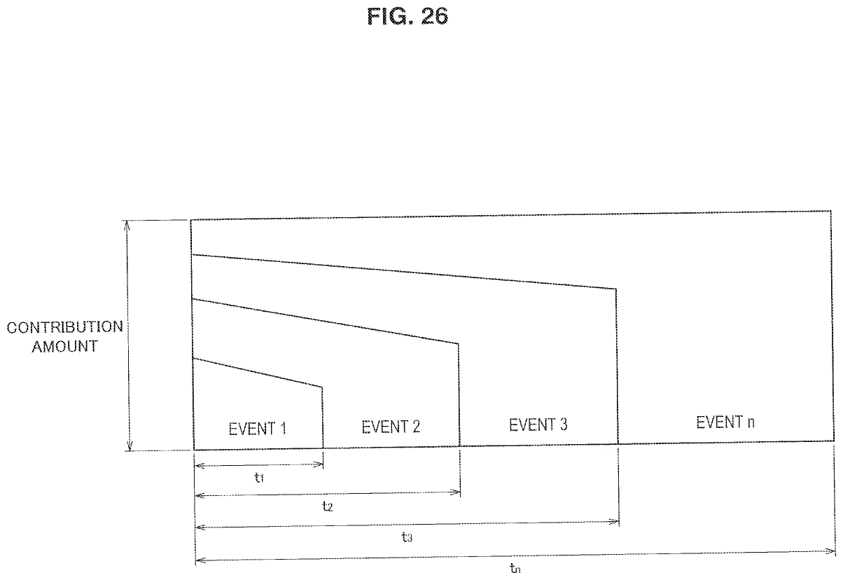

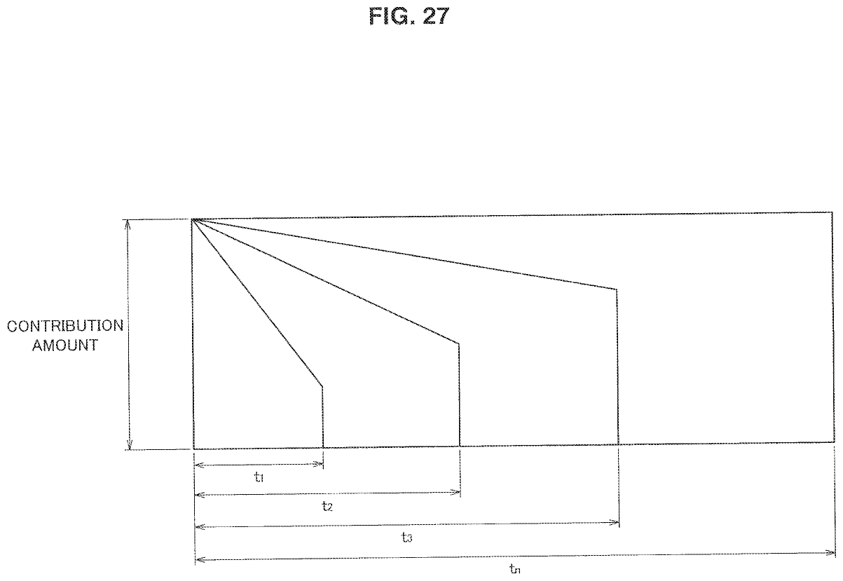

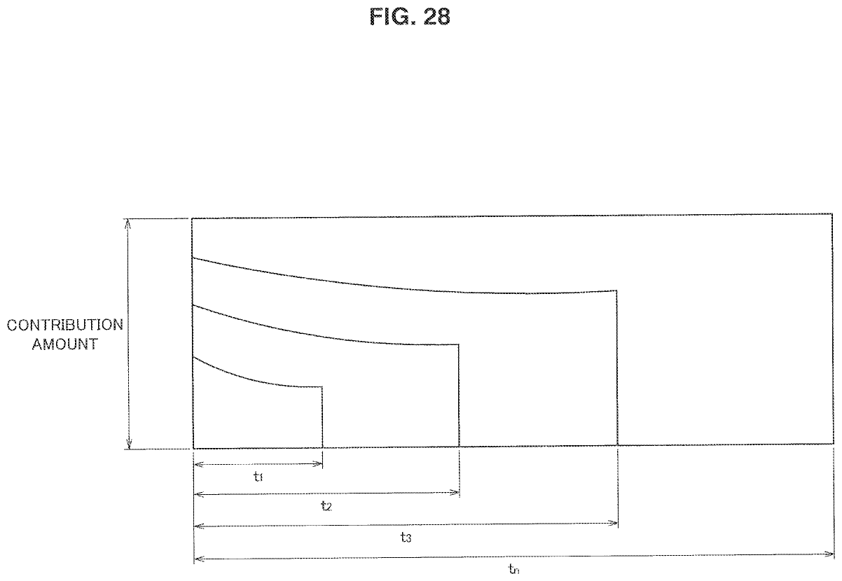

For example, as illustrated in FIG. 26, a model in which the sum total of the contribution amounts for Event 1 to Event n−1 decreases linearly over time in the period tₙ₋₁ may also be used. Also, as illustrated in FIG. 27, a model in which a contribution amount is allocated only to Event 1 at the start of management, and the contribution amounts allocated to other events increase over time may also be used. Also, as illustrated in FIG. 28, a model in which the sum total of the contribution amounts for Event 1 to Event n−1 decreases non-linearly over time in the period tₙ₋₁ may also be used.

### 5. REBALANCING

While assets are being managed in accordance with the asset management plan described above, price fluctuations in the financial market may cause the accumulated assets for each event not to develop as expected in some cases. For this reason, the administration server 20 includes the plan adjustment unit 248 that rebalances the asset management plan according to the actual asset management conditions. Hereinafter, a rebalancing method by the plan adjustment unit 248 will be described.

(1)

First, by subtracting the elapsed time since the start of asset management from the period Torig until the achievement time of each event at the start time of asset management, the plan adjustment unit 248 specifies a period Tnew until the achievement time of each event.

(2)

Subsequently, the plan adjustment unit 248 applies the current total valuation of all financial products as the initial investment amount, applies the monthly contribution amount in the original asset management plan as the monthly contribution amount, and creates a contribution plan for each event by a method conforming to Logic 1. After that, by following Logic 2 described above and applying the contribution plan, goal sum, and lower limit amount (the monetary amount ensured by principal-guaranteed financial assets) to Logic 2, the plan adjustment unit 248 computes the managed yield for achieving the goal sum for every event.

(3)

The plan adjustment unit 248 computes a new distribution of the initial investment amount to each financial product to achieve the computed managed yield for every event, and computes an initial investment amount for every financial product overall (Pn=a1n, a2n, . . . (where a1 and a2 correspond to each financial product, and a1n is the initial investment amount into financial products overall)).

(4)

Furthermore, the plan adjustment unit 248 computes, for every financial product, the difference between the initial investment amount for every financial product overall computed in

(3) and the current valuation (Po=a1o, a2o, . . . ) of each financial product in the current master portfolio.
(5)

Subsequently, for a financial product in which Pn has risen above Po, the plan adjustment unit 248 plans the buying of the difference between Pn and Po for the financial product, whereas for a financial product in which Pn has fallen below Po, the plan adjustment unit 248 plans the selling of the difference between Pn and Po for the financial product. With this arrangement, an initial investment amount for each event in a new contribution plan is obtained.

In this way, by performing rebalancing on the master portfolio rather than the virtual portfolios for each of the events, it is possible to minimize the amount of financial products to actually buy and sell as well as the fees that arise in association with buying and selling.

### (Supplement)

Note that in (2), an example is described in which the monthly contribution amount in the original asset management plan is applied as the monthly contribution amount and the managed yield is changed, but the managed yield in the original asset management plan may also be applied as the managed yield, and the monthly contribution amount may be changed.

Also, in the rebalancing method described above, the initial investment amount is allocated with priority given to the event with the closest upcoming achievement time. To avoid this, the plan adjustment unit 248 may also perform the rebalancing described above by distributing the current valuation of the current assets to each event according to the goal sum and the length of the remaining time period until the achievement time of each event, and treat the difference between the goal sum of each event and the distributed assets as a new goal sum. For example, the plan adjustment unit 248 may distribute the current valuation of the current assets to each event according to the ratio of (goal sum/length of remaining time period) of each event. According to such a configuration, it becomes possible to reduce the degree of change to the portfolio composition of each event.

In addition, the plan adjustment unit 248 may also perform the above rebalancing in the case in which the achievability of a goal falls to a threshold value or below, or in the case in which the possibility of a goal being achieved ahead of schedule becomes less than a set value. Also, although the above describes rebalancing that involves the buying and selling of financial products, the plan adjustment unit 248 may also propose changes to the contribution amounts, achievement times, goal sums, risk tolerances, or the like. The plan adjustment unit 248 may also perform the above proposing or rebalancing on the basis of client information, price information, foreign exchange information, and the like. The client information may include information acquired externally, such as bank savings information, credit card usage information, EC site utilization information and public institution information.

### 6. HARDWARE CONFIGURATION

The foregoing describes an embodiment of the present disclosure. Information processing such as the creation of an asset management plan and the rebalancing described above is realized by cooperation between software and the hardware of the administration server 20 described below.

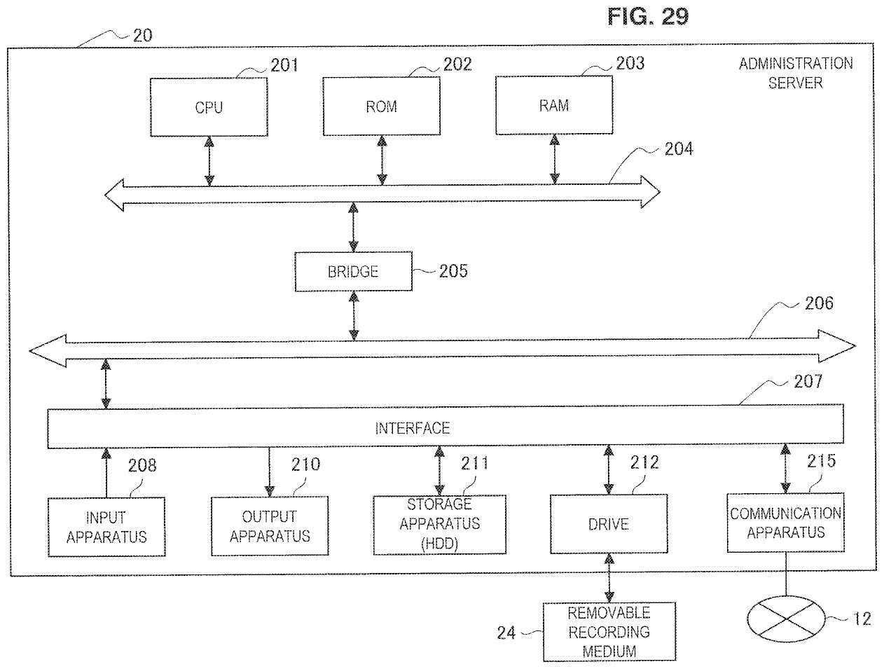

FIG. 29 is a block diagram illustrating a hardware configuration of the administration server 20. The administration server 20 is provided with a central processing unit (CPU) 201, read-only memory (ROM) 202, random access memory (RAM) 203, and a host bus 204. Also, the administration server 20 is provided with a bridge 205, an external bus 206, an interface 207, an input apparatus 208, an output apparatus 210, a storage apparatus (HDD) 211, a drive 212, and a communication apparatus 215.

The CPU 201 functions as a computational processing apparatus and control apparatus, and controls overall operation inside the administration server 20 by following various programs. Also, the CPU 201 may be a microprocessor. The ROM 202 stores programs, computational parameters, and the like used by the CPU 201. The RAM 203 temporarily stores programs used during execution by the CPU 201, parameters that change as appropriate during such execution, and the like. The above are interconnected by the host bus 204, which includes a CPU bus or the like. Through the cooperation of the CPU 201, the ROM 202, and the RAM 203, each function of the control unit 240 is realized.

The host bus 204 is connected to the external bus 206 such as a Peripheral Component Interconnect/Interface (PCI) bus via the bridge 205. Note that it is not strictly necessary to divide the configuration into the host bus 204, the bridge 205, and the external bus 206, and these functions may also be implemented in a single bus.

The input apparatus 208 includes an input means by which a user inputs information, such as a mouse, a keyboard, a touch panel, a button, a microphone, a switch, or a lever, an input control circuit that generates an input signal on the basis of input from the user and outputs to the CPU 201, and the like. By operating the input apparatus 208, the user of the administration server 20 is able to input various data and instruct the administration server 20 to perform processing operations.

The output apparatus 210 includes display apparatus such as a cathode ray tube (CRT) display apparatus, a liquid crystal display (LCD) apparatus, an organic light-emitting diode (OLED) apparatus, an indicator lamp, and the like, for example. Additionally, the output apparatus 210 includes audio output apparatus such as a speaker and headphones. The output apparatus 210 outputs played-back content, for example. Specifically, the display apparatus displays various information such as played-back image data as text or images. Meanwhile, the audio output apparatus converts played-back audio data or the like into sound, and outputs the sound.

The storage apparatus 211 is an apparatus used for data storage, realized as an example of the storage unit 230 of the administration server 20 according to the present embodiment. The storage apparatus 211 may include a storage medium, a recording apparatus that records data to the storage medium, a readout apparatus that reads out data from the storage medium, a deletion apparatus that deletes data recorded to the storage medium, and the like. The storage apparatus 211 includes a hard disk drive (HDD), for example. The storage apparatus 211 drives the hard disk, and stores programs executed by the CPU 201 and various data.

The drive 212 is a reader/writer for a storage medium, and is internally housed inside, or externally attached to, the administration server 20. The drive 212 reads out information recorded to a removable storage medium 24 such as an inserted magnetic disk, optical disc, magneto-optical disc, or semiconductor memory, and outputs the information to the RAM 203. Additionally, the drive 212 is also able to write information to the removable storage medium 24.

The communication apparatus 215 is a communication interface including a communication device or the like for connecting to the communication network 12, for example. By the communication apparatus 215, the functions of the communication unit 220 are realized.

Note that although the above describes a hardware configuration of the administration server 20 with reference to FIG. 29, since the hardware of the client terminal 10 may have substantially the same configuration as the administration server 20, a description of the hardware configuration of the client terminal 10 will be omitted.

### 7. CONCLUSION

As described above, according to an embodiment of the present disclosure, since an asset management plan is created for every event, and in addition, a virtual portfolio is administered for every event, it is possible to achieve asset management with an awareness of the occurrence of each event.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, the foregoing describes an example in which the client is able to set a sum total of the initial investment amount or a sum total of the contribution amount in the creation of a contribution plan, but the client may also set an initial investment amount or a contribution amount for each event in the creation of a contribution plan. In this case, the plan creation unit 244 creates a contribution plan on the basis of the initial investment amount or contribution amount for each event set by the client. According to such a configuration, it is possible to create a contribution plan that reflects the client's intentions in greater detail.

In addition, the plan adjustment unit 248 may also include a function of proposing a change of the contribution amount after asset management is started. For example, the plan adjustment unit 248 may propose a change of the contribution amount on the basis of a change in the client's earnings information or expenditure information. Also, the plan adjustment unit 248 may propose a change of the contribution amount in the case in which the management conditions are sluggish and the achievability has been lowered overall. Furthermore, the plan adjustment unit 248 may also propose an increase in the contribution amount in the case of determining that more profit than normal is desired, and propose a decrease in the contribution amount in the case of determining that profit is not desired.

Also, in the case in which the assets of a certain event reach the goal sum of the event, the administration unit 246 may distribute the contribution and return exceeding the goal sum to the asset management for other events. Alternatively, in the case in which the assets of a certain event reach the goal sum of the event, the administration unit 246 may sell the financial products of the event at the time when the goal sum is achieved, or sell the financial products of the event at the time when the scheduled achievement time arrives. Note that in the case in which the assets of a certain event reached the goal sum of the event, the display control unit 242 may also generate a display screen indicating goal achievement, and the communication unit 220 may transmit the display screen indicating the goal achievement to the client terminal 10. On the other hand, in the case in which the possibility that a goal will not be achieved by the scheduled achievement time exceeds a predetermined value, the display control unit 242 may generate a warning screen.

Also, in the case in which the progress of asset management exceeds the expected value line, the administration unit 246 may secure the profit by selling a portion of the risk-based financial products, and buy more principal-guaranteed financial products with the funds obtained by selling. Also, the administration unit 246 may detect a risk event timing, and the display control unit 242 may generate a display screen advising an increased cash position before the arrival of the risk event timing. Also, the display control unit 242 may generate a display screen providing guidance on decreasing the proportion of risk-based financial products as the scheduled achievement time draws near.

In addition, the display control unit 242 may also generate a display of a combined portfolio combining the master portfolios or the virtual portfolios for every event of multiple clients. According to such a configuration, it is possible to create a combined portfolio that indicates the asset management conditions for an entire family, for example.

Additionally, while asset management is being carried out in accordance with an asset management plan, in the case in which the client desires to add a new event, the plan adjustment unit 248 may create a new contribution plan for the new event. In this case, the plan adjustment unit 248 may allocate a contribution amount for the new event from the contribution amount for another event according to the goal sum and the achievement time for the new event. For example, as the other event, the plan adjustment unit 248 prioritizes the selection of an event having a high achievability of the goal, and does not select an event with a low risk tolerance as the other event. Note that in the case in which the achievability of the goal for each event is lowered greatly, the plan adjustment unit 248 may also propose an increase in the contribution amount or a change in the goal sum or the achievement time of each event.

Additionally, while asset management is being carried out in accordance with an asset management plan, in the case in which the client desires to remove an existing event, the plan adjustment unit 248 may reassign the assets that had been allocated to the removed event by giving priority to another event with a low risk tolerance or an event having a low achievability of the goal. In the case in which the reassignment causes an event to have an extremely high achievability of the goal, the plan adjustment unit 248 may also propose a low-risk portfolio composition for the event.

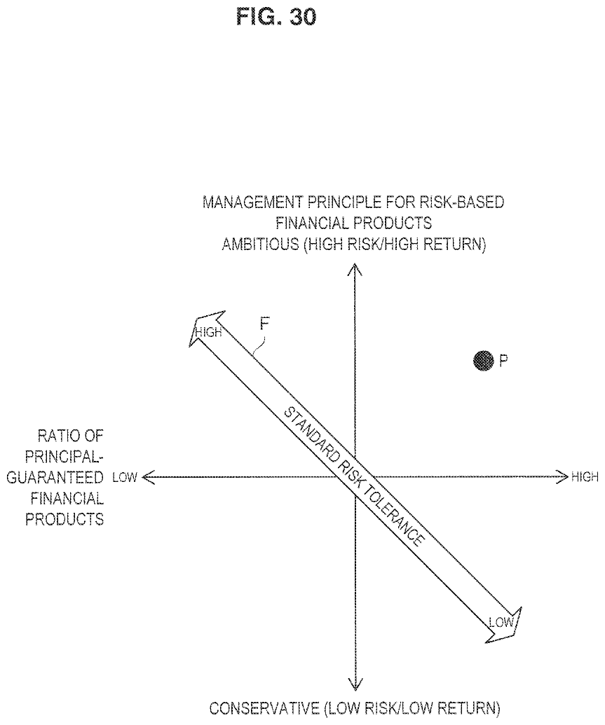

Also, although the above describes an example in which the risk tolerance corresponds to the worst-case guaranteed amount (lower limit amount), it is also possible to set even more detailed settings regarding the risk tolerance. Hereinafter, FIG. 30 will be referenced to describe an application of a risk-related setting.

FIG. 30 is an explanatory diagram illustrating an application of a risk-related setting. In FIG. 30, the horizontal axis corresponds to the ratio of principal-guaranteed financial products, while the vertical axis corresponds to the management principle for risk-based financial products. Normally, a low risk tolerance corresponds to a high ratio of principal-guaranteed financial products and conservative management of risk-based financial products as illustrated in FIG. 30. Also, a high risk tolerance corresponds to a low ratio of principal-guaranteed financial products and ambitious management of risk-based financial products as illustrated in FIG. 30.

However, as indicated by the plot P in FIG. 30, clients having desires that do not fit into the standard high/low risk tolerance, such as clients who desire a high ratio of principal-guaranteed financial products while also desired ambitious management of risk-based financial products, are also anticipated. Accordingly, a client may be enabled to set a detailed risk-related setting on a settings screen like the one illustrated in FIG. 30, and the plan creation unit 244 may create an asset management plan in accordance with the detailed risk-related setting. According to such a configuration, it becomes possible to create an asset management plan that reflects the client's desires in greater detail.

Note that the example screen for the detailed risk-related setting is not limited to the example in FIG. 30. For example, a screen that includes a slider for setting the ratio of principal-guaranteed financial products and a slider for setting the management principle for risk-based financial products may be provided.

Additionally, the plan display screen 600 described with reference to FIG. 10 may also display the settable range of the initial investment amount and the settable range of the contribution amount. The settable range of the initial investment amount may be a range between 0 yen and the goal sum of the event that arrives earliest, for example. Also, the settable range of the contribution amount may be a range between the minimum contribution amount and the maximum contribution amount described with reference to FIG. 24. According to such a configuration, the client is able to grasp the monetary amounts that are settable in the initial investment amount display field 602 and the contribution amount display field 604. Similarly, the settable range of the initial investment amount and the settable range of the contribution amount may also be displayed on the adjustment screen 900 described with reference to FIG. 16.

Also, each of the steps in the processes of the administration server 20 in this specification is not necessarily required to be processed in a time series following the sequence described as a flowchart. For example, each of the steps in the processes of the administration server 20 may be processed in a sequence that differs from the sequences described herein as a flowchart, and furthermore may be processed in parallel.

In addition, it is also possible to create a computer program causing hardware such as the CPU 201, ROM 202, and RAM 203 built into the administration server 20 to exhibit the same functionality as each component in the configuration of the administration server 20 described above. Also, a storage medium having the computer program stored therein is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing apparatus including:

a control unit that creates an asset management plan for each event on the basis of event information including a goal sum and an achievement time for every event.

(2)

The information processing apparatus according to (1), in which

the control unit generates a plan display screen illustrating the asset management plan for each event.

(3)

The information processing apparatus according to (2), in which

the plan display screen for a single event includes a display illustrating an initial investment amount and a contribution amount per a unit time period for the event.

(4)

The information processing apparatus according to (3), in which

the plan display screen for the single event includes a display illustrating a distribution of a contribution to each financial product or each financial product class.

(5)

The information processing apparatus according to (3) or (4), in which

the plan display screen for the single event includes a development prediction display illustrating how assets will develop in accordance with a created asset management plan.

(6)

The information processing apparatus according to (5), in which

the development prediction display includes a display illustrating a predicted range of performance for assets under management in accordance with an asset management plan.

(7)

The information processing apparatus according to any one of (2) to (6), in which

the plan display screen includes display areas for an initial investment total amount and a contribution amount per a unit time period according to the asset management plan.

(8)

The information processing apparatus according to (7), in which

in the display areas for the initial investment total amount and the contribution amount, an operation of changing the initial investment total amount and the contribution amount is possible, and

if the operation of changing the initial investment total amount or the contribution amount is performed, the control unit generates a plan display screen illustrating an asset management plan re-created on the basis of the changed initial investment total amount or contribution amount.

(9)

The information processing apparatus according to (2), in which

the control unit
generates a settings display for setting an amount of principal-guaranteed financial assets and a management principle for risk-based financial products, and
creates the asset management plan on an additional basis of the amount of principal-guaranteed financial assets and the management principle for risk-based financial products set on the settings display.
   (10)

The information processing apparatus according to any one of (2) to (9), in which

the control unit generates a screen for setting the event information.

The information processing apparatus according to (10), in which the control unit estimates an event that will occur with regard to a client or a goal sum and an achievement time corresponding to the event on the basis of client information, and generates a screen for setting the event information that includes a result of the estimation.

(12)

The information processing apparatus according to (10) or (11), in which

the screen for setting the event information includes an area for setting a risk tolerance for every event.

(13)

The information processing apparatus according to any one of (2) to (12), in which

the control unit generates a management conditions screen illustrating actual asset management conditions for each event.

(14)

The information processing apparatus according to (13), in which

the management conditions screen includes a display illustrating a distribution of assets to each financial product or each financial product class allocated to each event.

(15)

The information processing apparatus according to (13) or (14), in which

the management conditions screen includes a display illustrating an actual development of assets allocated to each event.

(16)

The information processing apparatus according to any one of (1) to (15), in which

the control unit acquires the event information including a risk tolerance for every event, and
on the basis of the event information including the risk tolerance, the control unit plans an initial investment amount and a contribution amount to each of a principal-guaranteed financial product and a risk-based financial product.
   (17)

The information processing apparatus according to (16), in which

the control unit
plans the initial investment amount and the contribution amount of the principal-guaranteed financial product such that assets of a lower limit amount obtained by multiplying a goal sum of a single event by a ratio corresponding to the risk tolerance are obtained by the principal-guaranteed financial product, and
plans the initial investment amount and the contribution amount of the risk-based financial product such that a monetary amount less than a difference between the lower limit amount and the goal sum of the single event is allocated to the risk-based financial product.
   (18)

The information processing apparatus according to any one of (1) to (17), in which

the control unit computes an adjustment value of a distribution of each financial product on the basis of asset management conditions at a point in time after the creation of the asset management plan.

(19)

An information processing method including:

acquiring a setting of a goal sum and an achievement time for every event; and creating, by a processor, an asset management plan for each event on the basis of the setting for every event.

(20)

A program causing a computer to function as:

a control unit that creates an asset management plan for each event on the basis of a setting of a goal sum and an achievement time for every event.

### REFERENCE SIGNS LIST

10 client terminal
12 communication network
20 administration server
220 communication unit
230 storage unit
240 control unit
241 estimation unit
242 display control unit
244 plan creation unit
246 administration unit
248 plan adjustment unit

1. An information processing apparatus comprising:
a control unit that creates an asset management plan for each event on a basis of event information including a goal sum and an achievement time for every event.

2. The information processing apparatus according to claim 1, wherein
the control unit generates a plan display screen illustrating the asset management plan for each event.

3. The information processing apparatus according to claim 2, wherein
the plan display screen for a single event includes a display illustrating an initial investment amount and a contribution amount per a unit time period for the event.

4. The information processing apparatus according to claim 3, wherein
the plan display screen for the single event includes a display illustrating a distribution of a contribution to each financial product or each financial product class.

5. The information processing apparatus according to claim 3, wherein
the plan display screen for the single event includes a development prediction display illustrating how assets will develop in accordance with a created asset management plan.

6. The information processing apparatus according to claim 5, wherein
the development prediction display includes a display illustrating a predicted range of performance for assets under management in accordance with an asset management plan.

7. The information processing apparatus according to claim 2, wherein
the plan display screen includes display areas for an initial investment total amount and a contribution amount per a unit time period according to the asset management plan.

8. The information processing apparatus according to claim 7, wherein
in the display areas for the initial investment total amount and the contribution amount, an operation of changing the initial investment total amount and the contribution amount is possible, and
if the operation of changing the initial investment total amount or the contribution amount is performed, the control unit generates a plan display screen illustrating an asset management plan re-created on a basis of the changed initial investment total amount or contribution amount.

9. The information processing apparatus according to claim 2, wherein
the control unit
generates a settings display for setting an amount of principal-guaranteed financial assets and a management principle for risk-based financial products, and
creates the asset management plan on an additional basis of the amount of principal-guaranteed financial assets and the management principle for risk-based financial products set on the settings display.

10. The information processing apparatus according to claim 2, wherein
the control unit generates a screen for setting the event information.

11. The information processing apparatus according to claim 10, wherein
the control unit estimates an event that will occur with regard to a client or a goal sum and an achievement time corresponding to the event on a basis of client information, and generates a screen for setting the event information that includes a result of the estimation.

12. The information processing apparatus according to claim 10, wherein
the screen for setting the event information includes an area for setting a risk tolerance for every event.

13. The information processing apparatus according to claim 2, wherein
the control unit generates a management conditions screen illustrating actual asset management conditions for each event.

14. The information processing apparatus according to claim 13, wherein
the management conditions screen includes a display illustrating a distribution of assets to each financial product or each financial product class allocated to each event.

15. The information processing apparatus according to claim 13, wherein
the management conditions screen includes a display illustrating an actual development of assets allocated to each event.

16. The information processing apparatus according to claim 1, wherein
the control unit acquires the event information including a risk tolerance for every event, and
on a basis of the event information including the risk tolerance, the control unit plans an initial investment amount and a contribution amount to each of a principal-guaranteed financial product and a risk-based financial product.

17. The information processing apparatus according to claim 16, wherein
the control unit
plans the initial investment amount and the contribution amount of the principal-guaranteed financial product such that assets of a lower limit amount obtained by multiplying a goal sum of a single event by a ratio corresponding to the risk tolerance are obtained by the principal-guaranteed financial product, and
plans the initial investment amount and the contribution amount of the risk-based financial product such that a monetary amount less than a difference between the lower limit amount and the goal sum of the single event is allocated to the risk-based financial product.

18. The information processing apparatus according to claim 1, wherein
the control unit computes an adjustment value of a distribution of each financial product on a basis of asset management conditions at a point in time after the creation of the asset management plan.

19. An information processing method comprising:
acquiring a setting of a goal sum and an achievement time for every event; and
creating, by a processor, an asset management plan for each event on a basis of the setting for every event.

20. A program causing a computer to function as:
a control unit that creates an asset management plan for each event on a basis of a setting of a goal sum and an achievement time for every event.
